(19) United States
(12) Patent Application Publication
(10) Pub. No.: US 2010/0211574 A1
(43) Pub. Date: Aug. 19, 2010

(54) Method and Apparatus for Obtaining Forensic Evidence from Personal Digital Technologies

(75) Inventors: Richard P. Mislan, Battle Ground, IN (US); Kyle D. Lutes, West Lafayette, IN (US); Neal S. Widmer, Battle Ground, IN (US); Mikel J. Berger, Camden, IN (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Purdue Research Foundation, West Lafayette, IN (US)

(21) Appl. No.: 12/602,957

(22) PCT Filed: Jun. 4, 2008
(86) PCT No.: PCT/US08/65773

§ 371 Date: Apr. 22, 2010

Related U.S. Application Data
(60) Provisional application No. 60/941,841, filed on Jun. 4, 2007.

(51) Int. Cl. G06F 17/30; G06F 13/00; G08B 5/00

(52) U.S. Cl. 707/748; 710/300; 707/E17.014; 340/815.4

(57) ABSTRACT

A system and method for personal digital technology forensics. The system and method can provide for the forensic identification, preservation, acquisition, analysis, presentation, exportation, and correlation of evidence obtained personal digital technologies including that obtained from cellular phones, personal digital assistants (PDAs), and smart phones.

### CROSS-REFERENCE TO RELATED APPLICATIONS

This application claims the benefit of U.S. Provisional Patent Application Ser. No. 60/941,841 filed Jun. 4, 2007, titled Forensic Rapid Evidence Extraction Analysis Kit (FREEAK), the disclosure of which is expressly incorporated herein by reference.

### TECHNICAL FIELD

The present invention generally relates to a method and system for the forensic identification, preservation, acquisition, analysis, presentation, exportation, and correlation of personal digital technology including, but not limited to a cellular phone, a personal digital assistant (PDA), smart phone, GPS devices, Subscriber Identity Module (SIM) cards, Multimedia cards, Universal Serial Bus (USB) stick drives, and audio and/or video recorder and/or player evidence.

### BACKGROUND

Forensics, also known as forensic science, attempts to answer questions particularly relevant to the legal system. Forensics can use scientific methods to examine facts, artifacts, or physical items to determine items of interest to the legal system. In particular, electronic information found in computers or other electronic devices can often be found to contain legal evidence useful in the support of legal investigations.

Personal digital technologies or devices include, but are not limited to Cellular Phones, Personal Digital Assistants (PDAs), Smart Phones, GPS devices, Subscriber Identity Module (SIM) cards, Multimedia cards, Universal Serial Bus (USB) stick drives, and audio and/or video recorders and/or players. These devices can hold critical time-sensitive information that may or may not relate directly to a legal investigation, criminal or otherwise. Most commonly, the information being sought includes: (1) Who the person knows, (2) Who the person has contacted most recently, (3) What the person has exchanged in terms of messages and the types of messaging systems involved, (4) What the person finds worth recording and storing (i.e. images, videos, sounds). Further information of relevance can include events in a calendar or images on a case-by-case specific basis. Ideally, any of this information is important in an investigation.

While still in its infancy, cell phone forensic technology appears to have changed very little over the past three years. Currently, a handful of products (see Table 1) employ command line physical acquisition protocols for file transfer such as AT, BREW, FBUS, MBUS, OBEX, and SyncML as would be understood by those in the art. The products in table 1 are intended for use mainly in the lab and not for use in the field. While some the products can be used in the field, such as UFED, CellDek, and Athena products, such products are not designed for such use, but are really intended for lab use only.

TABLE 1
CURRENT CELL PHONE FORENSIC
TECHNOLOGY COMPANIES

| Forensics Company | | |
|---|---|---|
| (1^{st}, 2^{nd} Target Market) | Product | Type |
| Cellebrite (US, Israel) | UFED | Hardware with Cables |
| Susteen (US, Canada) | Secure View | Software with Cables |
| Paraben (US) | Device Seizure | Software |
| Microsystemation (Euro, US) | GSM .XRY | Software with Cables |
| RadioTactics (Euro) | ForensicMobile | Hardware/Software |
| | Athena | |
| Envisage (Euro) | PhoneBase 2 | Software |
| Oxygen Software (Euro, US) | Phone Manager | Software |
| | II | |
| LogiCube (Euro, US) | CellDek | Hardware, Software with |
| | | Cables |

However, each of these products can include shortcomings as described in Table 2 as follows:

TABLE 2
Current Cell Phone Forensic Technology Shortcomings

| | |
|---|---|
| Cellebrite UFED | Purely hardware based product |
| | Uses proprietary cables (RJ-45 plugs) |
| | Built for telephone carriers to backup |
| | phones |
| | Not a forensic tool |
| Susteen Secure View | Solely software-based product |
| | Uses proprietary drivers |
| | Cables are specific to Secure View only |
| Paraben Device Seizure | Solely software-based product |
| | Driver installations can be problematic |
| | Sporadic performance |
| Paraben Device Seizure | Provides a dedicated cable set for cell |
| Toolkit | phones and PDAs. |
| | Incomplete at only 15 cell phone cables |
| | and 10 data cables. |
| Microsystemation GSM .XRY | Solely software-based product with |
| | proprietary hub |
| | Support for mostly Euro Phones |
| | Uses proprietary cables |
| Envisage PhoneBase2 | Support for mostly European Phones |
| | Solely software based product |
| Oxygen Software Phone | Nokia phones specific |
| Manager II | Soley software based product |
| Radio Tactics Ltd. Athena | High price ($20,000 USD) mobile kit |
| | Support for mostly European Phones |
| | Heavy: more than 30 pounds |
| | Separate cabling kit |
| LogiCube CellDek | High price ($25,000 USD) mobile kit |
| | Support for mostly European Phones |
| | Use Proprietary cables: RJ-45 plugs |
| | Initial release experienced bugs requiring |
| | updates |
| | Heavy: more than 30 pounds |
| | Deemed inadequate by many users. |

### SUMMARY OF THE INVENTION

Generally, the present invention relates to a method and system for the forensic acquisition, analysis, presentation, exportation, and correlation of evidence obtained from Personal Digital Technologies including, but not limited to, cellular phone, Personal Digital Assistants, Smart Phones, GPS devices, Subscriber Identity Module (SIM) cards, Multimedia cards, Universal Serial Bus (USB) stick drives, Digital Still Cameras and audio and/or video recorders and/or players. More specifically, the present invention facilitates a paradigm shift in digital forensics by placing the instrumentation of cyber triage at the scene of an investigation, to process the critical evidence before it loses its time value.

The present invention addresses the shortcomings of the current cell phone forensics industry and adds new functionality to vastly improve upon the current technologies. The present invention provides a truly mobile solution for rapid forensic triage of time sensitive data. The system can be used in either a mobile situation or lab environment for the immediate acquisition of evidentiary data from personal digital devices.

The present invention includes a hardened case to provide for easy transport and mobility. The top half of the case includes a touch screen computing device, which provides for substantially instant access capabilities typically required for fast forensics. The bottom half of the case includes an indexed storage area or compartment for approximately thirty (30) data connectivity cables of different types used by various manufacturers to connect to a variety of personal digital technologies. These cables can be locked into place to reduce the likelihood of loss.

The present invention is directed to a number of functional aspects including mobility, software, process, acquisition (connectivity), analysis, and presentation of information.

The present invention provides a substantially portable mobile device which is lightweight, compact in size, battery operated, and easy to use.

The successful mobility of the present invention includes a modular concept having instant-on forensic acquisition capabilities and wired or wireless access to the personal digital technologies. In one aspect of the present invention, the system includes a kit which is no larger than 8.5″×11″×3.5″ and can be AC or DC powered. The kit is self-contained and when closed includes all the necessary tools to perform rapid forensic triage on a multitude of devices. The present invention includes a touch-screen interface and hot swappable device connectivity. The present invention also provides a solution for managing the many data connection cables to substantially prevent cable loss or damage.

In addition, the present invention includes a software based system which guides an examiner or generalist (user) through device acquisition, analysis, presentation, and exportation. Software code residing on a tablet computer includes the capability of leveraging multiple manufacturer and communication specific protocols for the rapid acquisition of device information.

The present invention also can provide for the fast acquisition of a number of types of information including device characteristics and user generated or user received information. Such types of information include hardware identification, software identification, phone number, contacts, call histories, e-mails, calendars, images, videos, SIM card and other related card type information, text messages, and multimedia information.

The present invention includes the technology to save the captured data to a portable memory device, exported to a general repository for data mining purposes, or output to a printer.

According to one exemplary embodiment of the present invention, the on-screen identification system accurately portrays the mobile phone and illuminates the corresponding connectivity cable in the bottom half of the device.

Once a device is selected by the user, the system illuminates the data connection and the means for connectivity, sending a request to the data port until the device is connected. Upon connectivity, the system begins forensic acquisition of device specific information which can include: Make, Model, Software Revision, International Mobile Equipment Identifier, Phone Number, Contacts, Call History, E-mail, Text Messages, Calendars, Images, and videos, Other files, and other pieces of data as necessary. Once acquired, system prepares on-screen reporting and options for saving to memory device or exporting to general repository for data mining purposes. Raw data is retrieved from device and displayed in a user readable format as well as raw format. This is user selectable during and after acquisition.

The system includes a plurality of cables which are continually connected through a multiplexed USB hub and illuminate on command.

A menu on a touch screen displays a number different manufacturers and models of digital devices which can be analyzed by the kit. A model to be analyzed is selected from the menu by the user. Once the device model is selected, the software illuminates a specific single data cable which is directly connected to the kit through a pre-determined data port. By continually requesting data from the specified single data cable, the actual device to be analyzed can be acquired upon connection to the cable. Once the device is connected to the appropriate cable, the system recognizes the device and begins acquisition of the data.

The system includes the functionality of being programmed to extract the most significant evidence expeditiously. Such information includes the following:
Phone Information: manufacturer, model number, and other identifying numbers;
Contacts: who does this person know, or has s/he been involved with;
Call History: who has this person contacted, or who has contacted this person;
Text Messages: determines who this person communicates with;
Images/Videos: the names of what has this person seen or found worthy of capturing.

The system includes features for saving information to a USB memory stick, a variety of memory cards, or a PostScript Document Format (PDF) report or print preview.

Additionally, the system can securely export data through web services via multiple wired or wireless methods to a secure database for correlation against previously entered data. Data that can be correlated can include personal device numbers, contact numbers, numbers from call history, and numbers from text messages. Other data includes words, phrases, letters, or more specifically names from contacts, call history and text messages.

The system can facilitate multiple units sending data from multiple sites and performing a correlation for intelligence purposes. One specific use can be as an intelligence tool for Department of Defense, the Drug Enforcement Agency, the Department of Homeland Security, Customs and Border Patrol, and/or Immigrations and Customs Enforcement.

### BRIEF DESCRIPTION OF THE DRAWINGS

The detailed description of the drawings particularly refers to the accompanying figures in which:

FIG. 1 is a perspective view of the forensic system of the present invention;

FIG. 2 is a top view of the forensic system of the present invention when open;

FIG. 3 is a perspective view of the forensic system of the present invention when closed;

FIG. 4 is a partial perspective view of the forensic system of the present invention including a handle having multiple positions.

FIG. 5A is a partial perspective view of the bottom half of the forensic system of the present invention;

FIG. 5B is a schematic representation of the layout of cables partially illustrated in FIG. 5A.

FIG. 6 is a flow-chart illustrating the steps performed to identify, preserve, acquire, analyze, present, and export the personal digital technology evidence;

FIG. 7 is a flow chart of the use of the home screen of the present invention;

FIG. 8 is one embodiment of a user interface screen of the present invention to select a device for analysis;

FIG. 9 is one embodiment of a forensic acquisition flow chart;

FIG. 10 is one embodiment of an on screen reporting flow chart;

FIG. 11 is one embodiment of a correlation flow chart;

FIG. 12 is one embodiment of a user interface screen of the present invention showing an initial repository state;

FIG. 13 is one embodiment of a multiple unit access flow chart;

FIG. 14 is one embodiment of an evidence repository diagram.

FIG. 15 is one embodiment of a home user interface screen.

FIGS. 16-35 are embodiments of user interface screens which can be reviewed upon selection of one of the icons in the interface screen of FIG. 15.

### DETAILED DESCRIPTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present inventions.

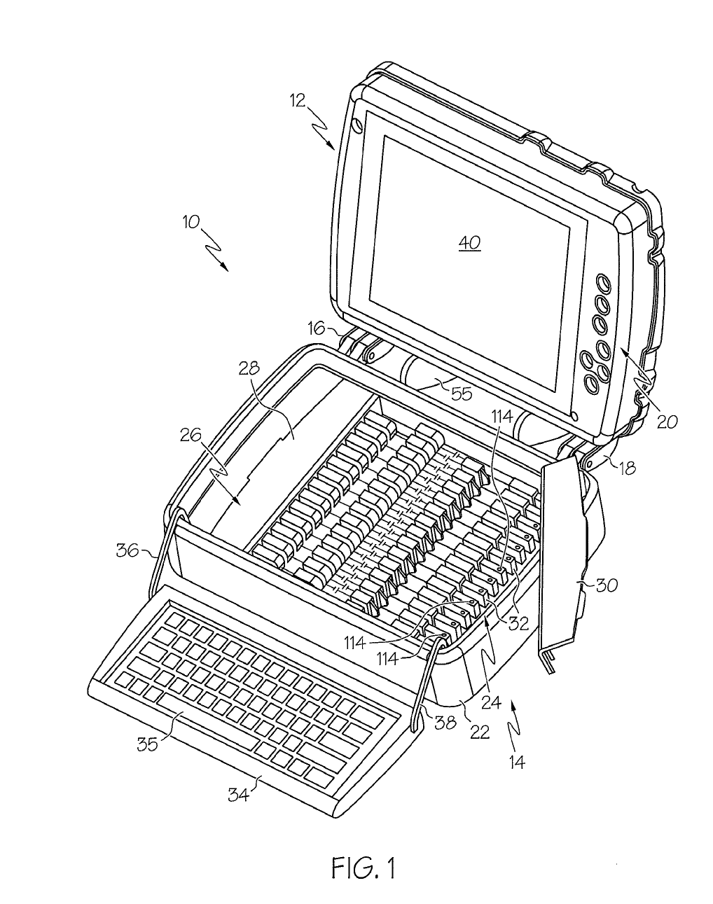

FIG. 1 illustrates a perspective view of a forensic system 10 of the present invention. The forensic system 10 includes a military specification tablet personal computer (PC) 12 which can be obtained from a variety of vendors. For instance, the Mil Spec Tablet PC of the present invention can include Duo-Touch II Tablet PC available from General Dynamics Itronix Corporation, of Spokane Valley, Wash., USA. The General Dynamics Table PC includes a dual core multithreaded processor which is particularly applicable to the current invention as described herein. The processor provides for increased parallelization of the completion of multiple tasks. Consequently, the present invention can provide for real time viewing of data as it is obtained by the current invention. The use of a dual core processor also provided faster processing, a simplified design of the software programs, and increased robustness.

While the current embodiment includes the described tablet PC available from General Dynamics, other tablet PCs from other manufacturers can also be used. It is preferred that such PCs include mil spec PCs having parallel processing, a hardened or ruggedized case, and a touch screen. In addition, depending on the particular application of the system 10, it is also possible to use other available computing devices. The computing devices being used can be either hardwired devices or can accept wireless signals as is understood by those skilled in the art. It is also within the scope of the present invention to manufacture the forensic kit 10 as a single device where the entire unit is manufactured by a single entity.

The Tablet PC 12 is coupled to a bottom portion 14 by a first hinge 16 and a second hinge 18. Hinging of the tablet PC with the bottom half provides a closeable unit substantially impervious to the elements. The Tablet PC 12 also includes a number of user accessible controls 20 as is understood by those skilled in the art.

The bottom 14 includes a concave shell 22 adapted to receive a first USB hub 24 located along one longitudinal side of the concave shell 22. A second USB hub 26 is located along a second and opposite side of the concave shell 22. The second USB hub 26 is hidden by a cable cover 28. A second cable cover 30 is shown exploded away from the concave shell 22 to illustrate the location of the USB hub 24. Each of the USB connection hubs 24 and 26 (multiplexed data connectivity unit) include a plurality of USB connectors 32. Each of the USB connectors 32 are coupled to the tablet PC 12 through the USB hubs as would be understood by those skilled in the art. In one embodiment of the present invention, there are approximately 15 USB connectors 32 located on the USB hub 24 and 15 USB connectors 32 located at the second USB Hub 26.

A keyboard tray 34 can be coupled to the concave shell 22 through a first hinge 36 and a second hinge 38. The keyboard tray can include a keyboard 35 and would fold into the bottom 14 such that the keyboard and shelf are enclosed when the system 10 is closed. As illustrated, the tablet PC 12 also includes an input device, such as a touch screen display 40 as is understood by those skilled in the art. Other input devices are also within the scope of the present invention and can include voice activated software, computer mouses, and joysticks.

The system of FIG. 1 can include a harness (not shown) as is understood by those skilled in the art to enable the system to be attached to a user's chest while being used. In this way, the present invention is particular useful in field situations where a support surface is not available. The device can therefore be suspended from a user for use while the user is standing up or in other positions as well.

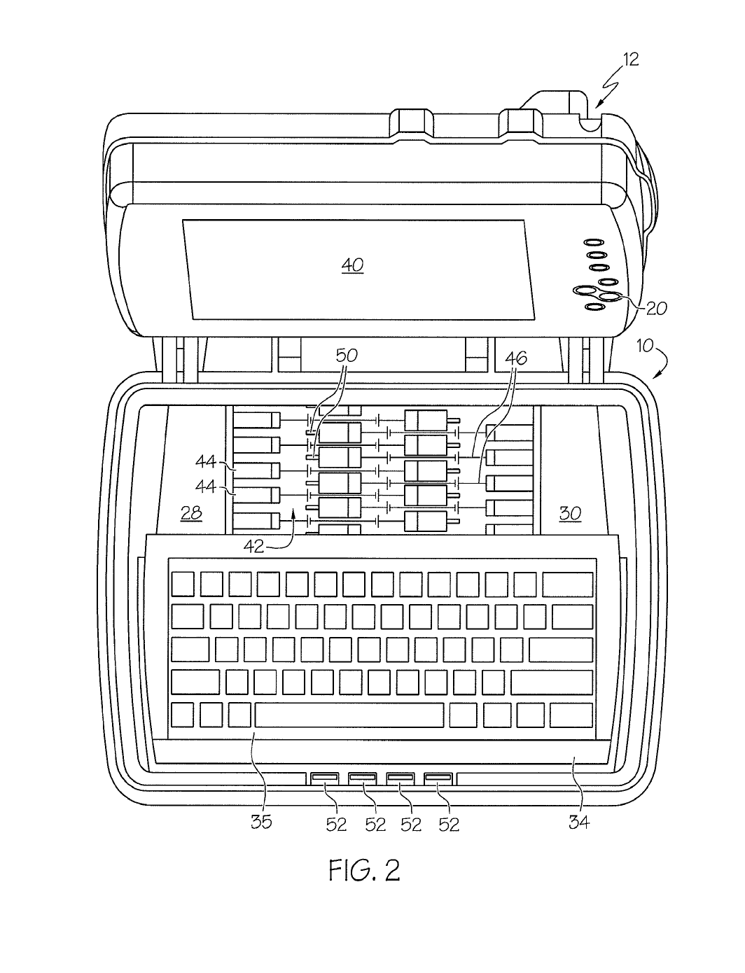

FIG. 2 illustrates a top view of the forensic system 10 in an open condition where the tablet PC 12 has been moved away from the concave shell 22 such that the touch screen display 40 is accessible by a user. In addition, the keyboard 35 is shown in the storage position. In the open condition, the user has access not only to the touch screen display 40 and the user accessible controls 20, but also to a number of cables 42 which have a first end 44 coupled to a respective USB connector 32, which are not seen in this particular figure due to the cable covers 28 and 30 being in place. Each of the first ends 44 of a respective cable includes a USB connector which can couple to a corresponding USB connector located at the USB hubs 24 or 26. Each of the first ends 44 are coupled through a wire harness 46 to a respective connector 48. The connectors 48 include a terminating portion or terminal 50 each of which are specifically selected to connect to a particular personal digital device being examined by the forensic system 10.

The forensic system 10 of the present invention in one embodiment can accommodate thirty (30) different types of cables 42. The cables 42 can be selected by the manufacturer of the system 10 or by the purchaser or user forensic system 10. The included cables are typically selected according to a region or area where the device is typically used. The present invention can accommodate any number of personal digital device cables as long as the case or bottom shell of the device is large enough to hold each of the cables. It has been found, however, that the number of thirty cables is typically sufficient in most cases to provide for the examination of a majority of the digital devices typically encountered in the field in a certain region. Even though each of the cables 42 has been preselected, they can also be removed and changed in the field if necessary if damaged. As further illustrated in FIG. 2, the bottom portion 14 also includes an additional number of USB ports 52. As illustrated, four USB ports 52 are included and can be used as necessary. It is within the scope of the present invention to have any number of extra USB ports 52. The bottom portion can also include other connecting devices SIM card readers, memory card readers.

While the present invention can include a predetermined number of cables 42, the present invention can analyze a much larger number of digital devices. For instance, a single cable can have a specific type of connector which can connect to many different types of devices available from different manufacturers. Consequently, even though multiple devices can connect to a single cable, the present invention can determine the type of device being connected to a single cable when the cable can accommodate multiple devices.

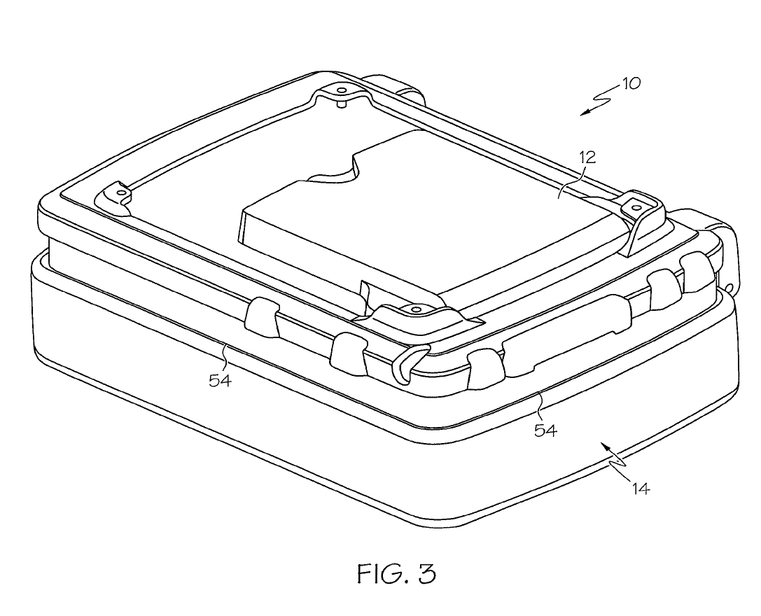

FIG. 3 illustrates a perspective view of the forensic system 10 in a closed condition. As illustrated, the top portion of the forensic system 10 includes the tablet PC 12. The bottom portion 14 has been designed to accommodate and to meet with the edges of the tablet PC 12 such that an interface 54 between the bottom 14 and the tablet PC 12 provides a substantially water tight seal for use in the field when closed.

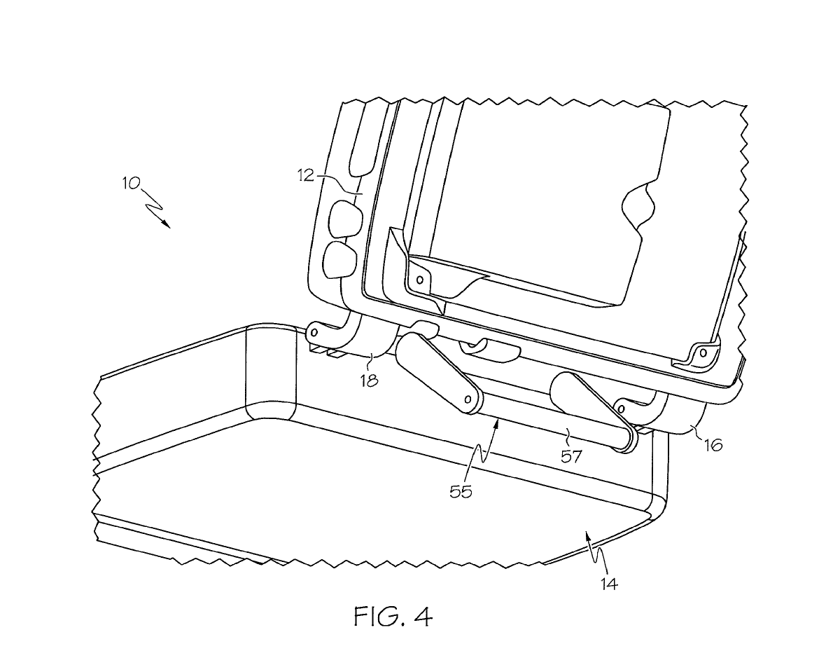

FIG. 4 is a partial perspective view of the system of the present invention including a handle 55. The handle 55 is coupled to first and second hinges 16 and 18 respectively. The handle 55 can move between and be located in any one of multiple and distinct positions. When the device 10 is closed, the handle can be straight up or straight down with respect to the side surface of the bottom portion 14. The handle can extend parallel with respect to the bottom surface of the bottom portion. In addition, the handle can extend either 45 degrees down as illustrated or 45 degrees up when the system is also closed. The handle includes a splined or ratcheted connector to couple the handle to the case. The handle can therefore be positioned in any one of the predetermined positions and remain in place until moved. The handle includes a rotatable grip 57.

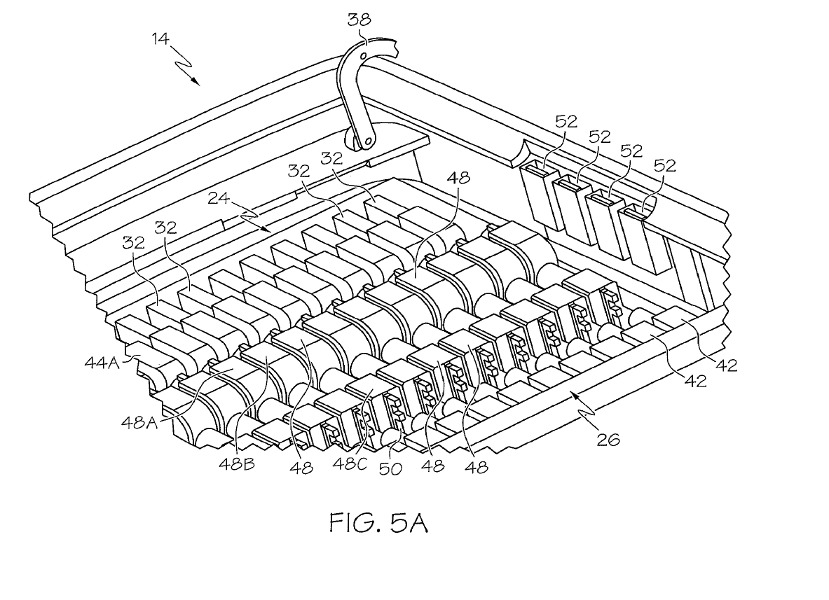

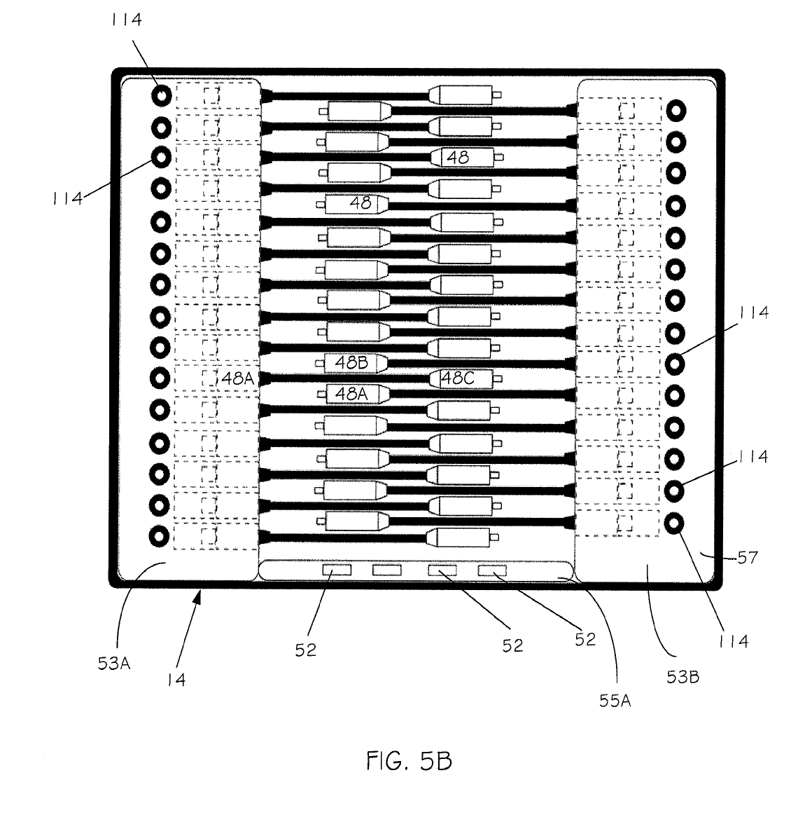

FIG. 5A illustrates a partial perspective view of the bottom 14 of the forensic system 10 including the hinge 38. As can be seen, the cable covers 28 and 30 have been removed to illustrate a portion of the plurality of USB connectors 32. Each of the plurality of USB connectors 32 include a respective cable 42 coupled thereto. In this figure, it can be seen that wiring harnesses of the cables 42 are interlaced with respect to one another. The wiring harness of a single cable will be located between adjacently located connectors 48. For instance, as illustrated in FIG. 4, a cable having a first end 44A coupled to a selected USB connector at the USB hub 24 includes a wiring harness which passes between connectors 48A and 48B of cables coupled to the USB hub 26. The wiring harness of first end 44A (not in view) is coupled to the respective connector 48C which includes the terminals 50. Consequently, each of the data cables can be intertwined with respect to one another to therefore provide a relatively organized set of cables providing easy access to a user.

FIG. 5B is a schematic representation of the layout of cables partially illustrated in FIG. 5A. In addition to illustrating the layout of adjacent cables with respect to one another, the figure also illustrates the interchangeability of cables through the use of pre-configured cable inserts 53A, 53B, and 55A. Inserts 53A and 53B includes a cable support 57 each of which include a single USB hub and the appropriately connected cables. By making the USB hub and related cabling modular, the cables appropriate for a particular region or area can be easily changed if a device 10 is moved to a different location. As can be seen each of the modular inserts can include the light devices 114. In addition, the USB hub 55A can be changed to include any number of USB connectors or other types of connectors including SIM card connectors and memory card connectors. The SIM card connectors can connect to SIM card readers and the memory card connectors can connect to memory card connectors as would be understood by those skilled in the art.

It is also within the scope of the present invention to provide the bottom portion 14 of the present invention as a completely self contained unit including the cables, the USB hubs, and the other described elements as a single unit. The unit can include a cover to completely enclose the bottom portion and an external cable or cable connector to enable connection of the unit to a lap top computer, another table PC, a personal computer, or other computing device. In one example, the self-contained digital device connecting unit could be coupled to a laptop carried in a police squad car.

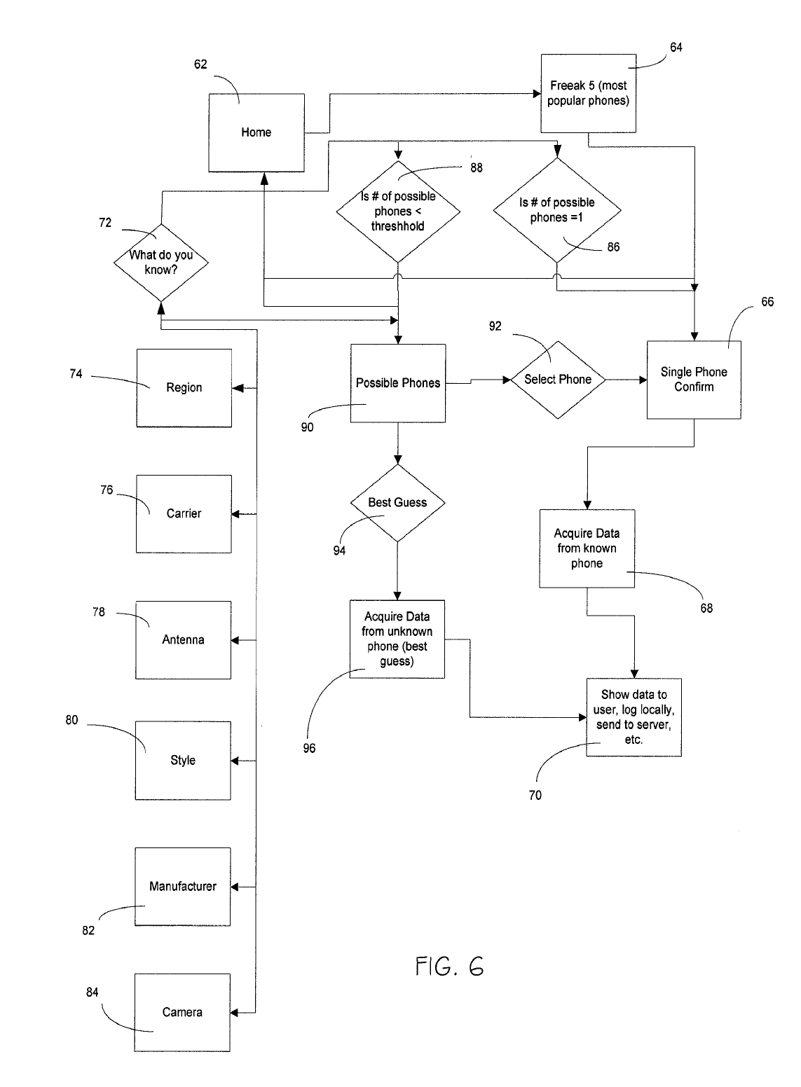

FIG. 6 illustrates a flow diagram 60 of the present invention indicating the identification, acquisition, analysis, and presentation modes of the present invention. As illustrated in FIG. 5, the system typically begins at a home screen 62, to be described later herein. At the home screen, a user can select from a variety of the most popular phones or devices at step 64, typically the phones whose cables have been placed and prepositioned in the bottom half 14 of the concave shell 22 as previously described. Once a particular phone has been selected at step 64, the phone can be confirmed at step 66 by plugging the phone into the preselected cable. After the phone has been confirmed at step 66, data can be acquired from the phone at step 68. The data can include a variety of information to be described more fully herein. Once the data has been acquired at step 68, the data is shown to a user at step 70 on the user interface screen 40 of the tablet PC 12.

If the user is having difficulty identifying the phone, at step 72 the system 10 can provide a variety of prompts which can narrow down the type of phone being analyzed from a number of possible phones. For instance, at step 74, if a region or area of the world or country or region is generally known, the user can select that area to thereby narrow down the types of devices typically sold or used by in that particular area. It is also possible to further identify cell phones from a general knowledge of the carrier at step 76. Oftentimes a device can be generally recognized by the type of antennae at step 78. It is also possible to identify phones by the style of phone at step 80, the manufacturer at step 82 and whether or not a camera exists on the phone at step 84. If this winnowing process which occurs at steps 74 through 84 reduces the number of possible phones to one, then at step 86 the system will move to the single phone confirm step at step 66 as previously described.

If, however, the number of possible phones or digital devices has not been narrowed to one at step 86, then at step 88 a check is made to determine whether or not the number of possible phones is less than a threshold. For instance, the threshold can be set to a particular number by either the manufacturer of the device depending on the current software version being used or can be established by a user in the field through inputs available at the interface screen 40. If the number of possible phones is less than a threshold then at step 90, those possible phones provide the user an option to select a phone at step 92 and confirmed at step 66. If, however, the number of possible phones only yields a best guess of a phone at step 94, then the phone or device 94 can be placed in the system 10 for obtaining forensic information and data can be acquired from that phone at step 96. Of course, because the phone is unknown at step 96, the data could be suspect, but step 96 can also yield sufficient data for further review by a user at step 70.

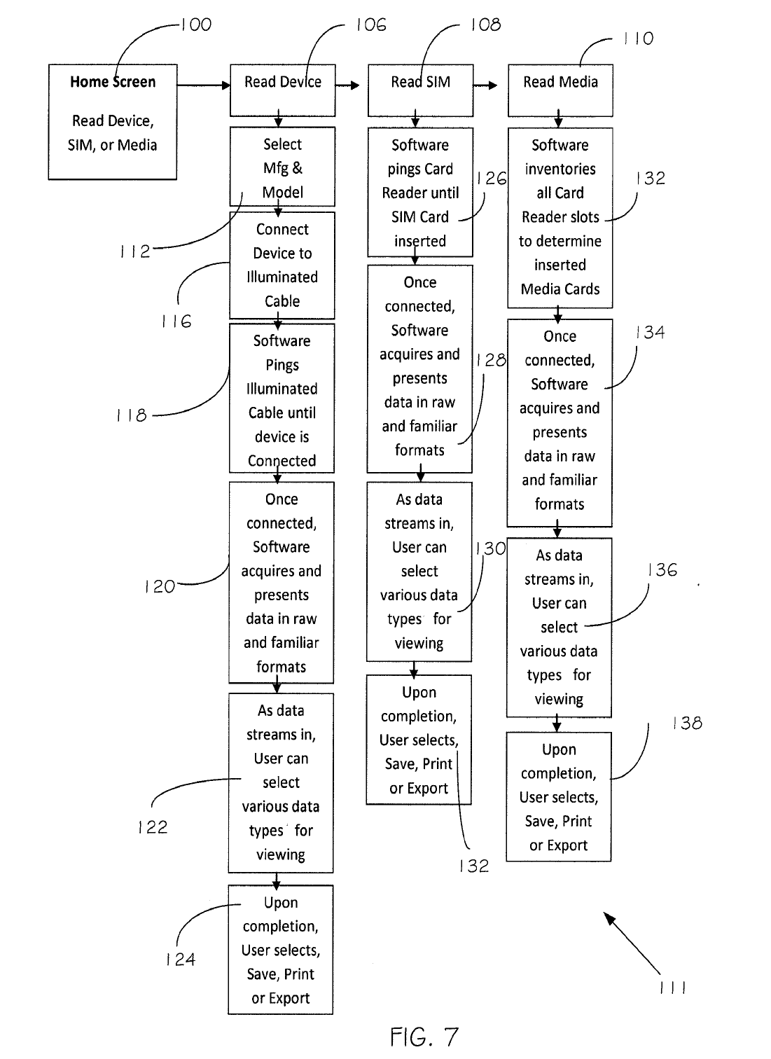

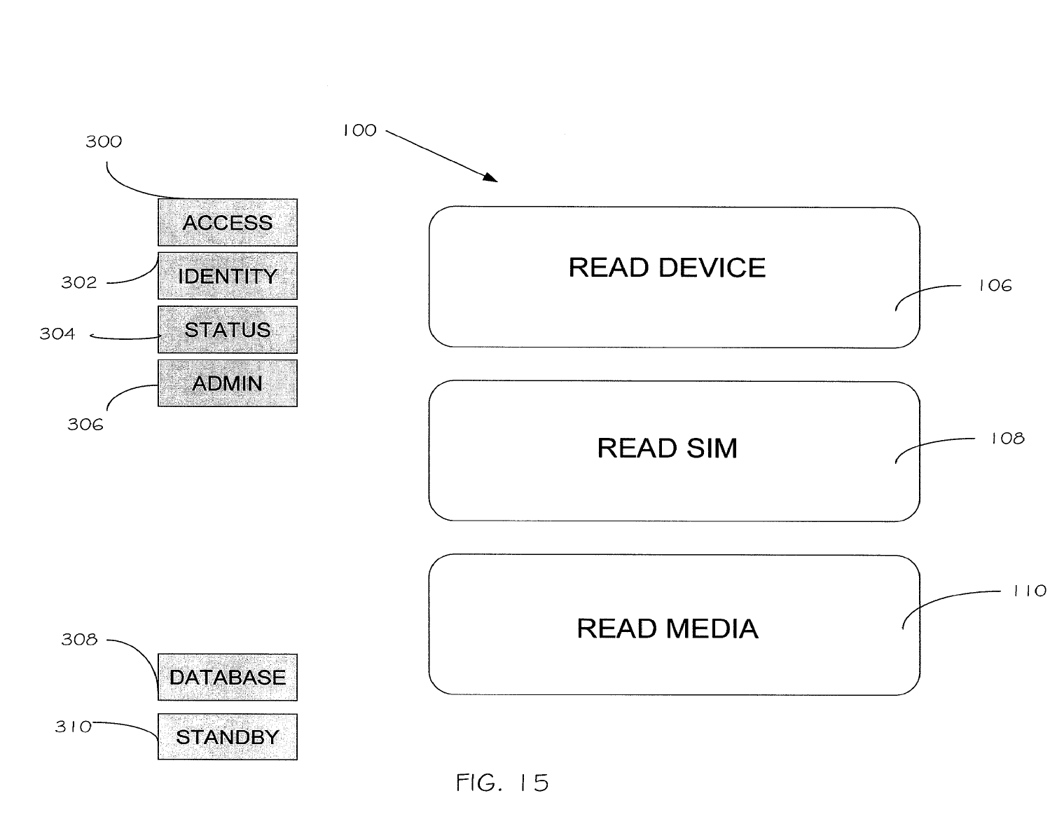

FIG. 7 illustrates a software flowchart 111 of the present invention where a home screen 100, to be described later herein, in FIG. 15 is illustrated to begin the software flowchart. If, for instance, a read device icon 106 has been selected, a new screen opens up at step 112 where a user can select from among a variety of manufacturers and models.

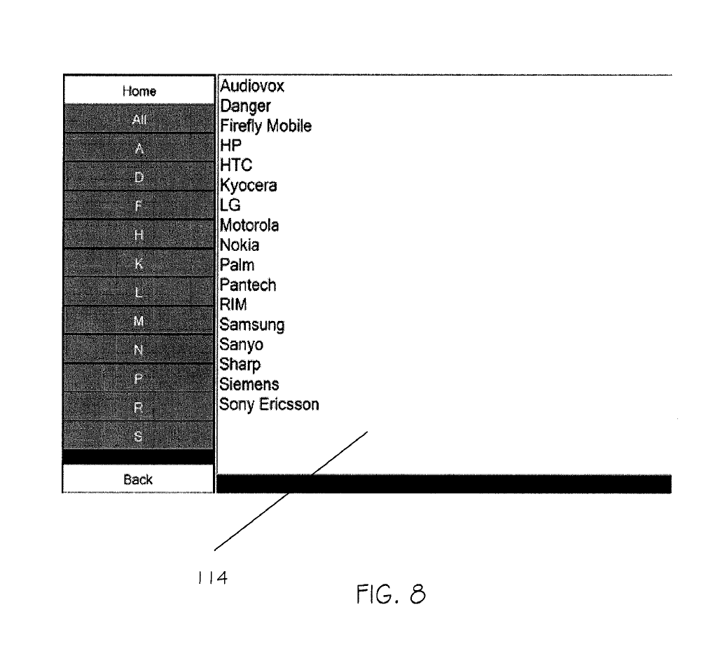

FIG. 8 illustrates one such user interface touch screen 114 which can appear upon the selection of the manufacturer and model icon at step 112. As can be seen, the user interface screen of FIG. 8 includes an index along the left hand side where the various devices are organized alphabetically, the first letter of each of the available devices being shown. Since the system 10 is configurable according to a desired set of devices and device cables, not all letters appear in the index. As can be seen, each of the first devices representing each of the letters in the currently embodied configuration are shown to the right. For instance, for the letter A, Audiovox is shown. For the letter D, Danger is shown. For the letter F, Firefly Mobile is shown and so on. Once the particular letter is selected, a number of additional manufacturers and/or devices will be shown, each of which begins with the letter corresponding to the selected device. Once the user has selected a particular manufacturer and model, the system software can identify the location of the cable which corresponds to the selected device. Because the cables have been connected to respective USB hubs 24 and 26, in a defined manner, the software can locate the respective cable by identifying the appropriate connector 32 of FIG. 1. Each of the respective connectors 32 includes an illumination device 114 as can be seen in FIG. 1. The illumination device, most typically a light emitting diode, can be illuminated by the software to indicate which of the respective cables has been selected.

The cable covers 28 and 30 located above the respective USB connectors can be either transparent or can include a plurality of apertures such that the LED will be viewable to the user. Once the particular connector 32 has been illuminated, the user connects the device to the illuminated cable at step 116. Once connected, the software pings the illuminated cable until the device is connected electronically to the system at step 118. Once connected, the software acquires the data located on the connected device at step 120. As the information is being acquired from the device, the information can be displayed for viewing in real time by the user. The information can be displayed in either a raw format or a more familiar format as determined by the user or by the manufacturer. As the data continues to stream in and is acquired by the software, the user can select various data types for viewing (not shown) on a user interface screen. For instance, the various data types that can be viewed include contacts, call history, text messages, calendar events, emails, task lists, file names, file name types, file name sizes, routes, and way points for a device. Once the various data has been viewed by the individual user at step 122, the user can upon completion of the examination of all of the acquired data select, save, print, or export the data at step 124.

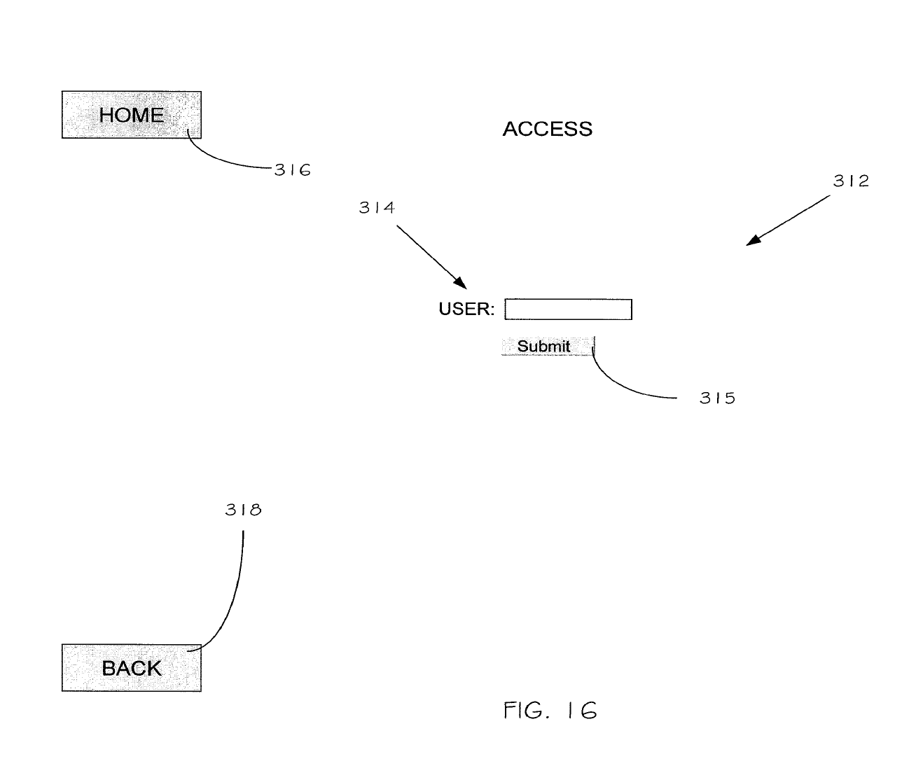

If the user decides to read the SIM card at the icon 108 of FIG. 16, the software pings the SIM card reader at step 126 until the SIM card is inserted. The present invention and forensic system 10 include a SIM card reader, wherein the SIM card is typically removed from the device being examined and placed in the SIM card reader at step 126. Once connected to the SIM card reader, the SIM card is examined by the software where the software acquires and can present the data in raw and familiar formats such as described when the device is being read at step 128. As the data streams in from the SIM card being read, various data types can be viewed by the user. For instance, data types from a SIM card include contacts, a call history, and text messages at step 130. As before, upon completion of the acquisition of the data and viewing by the user, the user can select the information desired and either save that information, print that information, or export that information to another device at step 132.

If the user has selected the read media icon 110 of FIG. 16, the software inventories all card reader slots at step 132 to determine whether the inserted media cards have been removed from the particular device and inserted therein. The present forensic system 10 includes one or more card reader slots each of which is specifically designed to accept a particular type of media card at step 132. Once the software recognizes that a card has been inserted into a card reader slot, the software acquires and presents data in both raw and familiar formats to a user at step 134. After the data streams in, the user can select the various data types for viewing from the media. Various data types for media cards can include files, documents, images, videos, and other types of data known by those skilled in the art at step 136. Upon completion of acquisition of data by the system, the user can select the type of data being presented for saving, printing, or exporting at step 138.

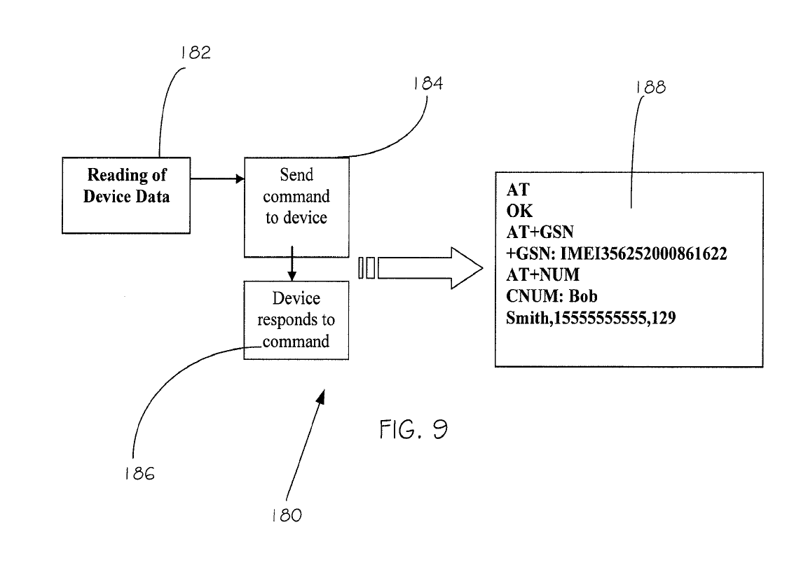

FIG. 9 represents one embodiment of a forensic acquisition flowchart 180. The flowchart 180 includes the first step of reading the device data at step 182. To read the device data, a command 184 is sent by the tablet PC 12 to the particular device which has been connected to one of the cable as previously described. If the device responds to the command, assuming that the device is operational and is the correct device, then at that point the device will respond at step 186. The response by the device at step 186 is illustrated at block 188. Block 188 illustrates a screen display of one possible display on the user interface screen. As illustrated in 188, the user interface screen indicates that the device has been confirmed by the “OK” sign, that the device includes an international mobile equipment identity number as indicated, and that the particular cell phone number has been assigned to a Bob Smith having the 10 digit number as illustrated.

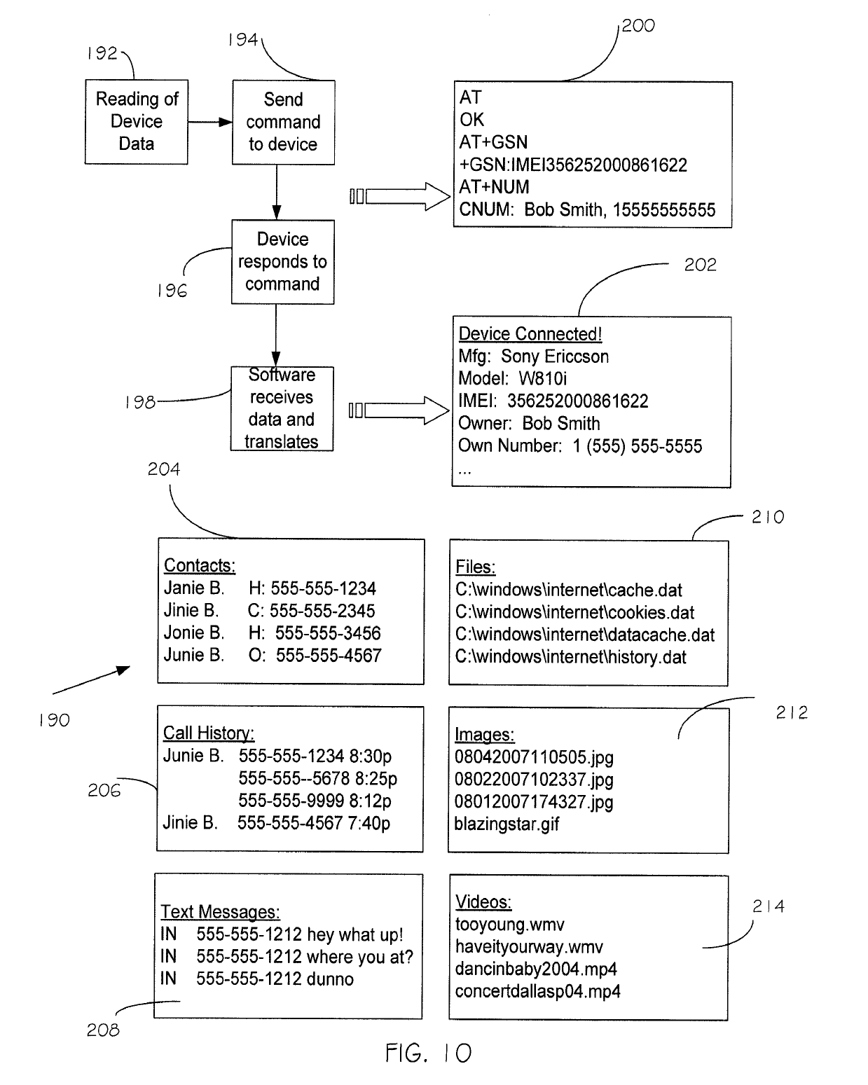

FIG. 10 illustrates one embodiment of an on screen reporting flowchart 190 used during the reading of device data at step 192. As previously described with the flowchart of FIG. 9, a command is sent to the device at step 194 as would be understood by those skilled in the art. Once the device responds to the command at step 196 the software begins to receive data and translates the data at step 198. The software is resident on the tablet PC 12.

As can be seen from the flowcharts of FIG. 9 and FIG. 10, once the device responds to the command, a screen 200 includes an indication that the device has correctly responded, that the IMEI number has been identified, and that the owner of the device as well as the phone number of the device have also been identified. Once the software receives the data and begins the translation, at step 198, the user interface screen, as illustrated at block 202, identifies the connected device. In this case, the device is a Sony Ericsson device having a model number, the EMI number, the owner, and the device phone number. In this instance, the software has taken the data of block 200 and has organized it into a form more easily usable by a user. In addition, during reading of the device data, the software also provides additional information in a format usable by a user. Block 204 lists a number of contacts. Block 206 lists a call history. Block 208 lists the text messages found. Block 210 lists certain files located in the C drive. Block 212 lists four images. Block 214 lists four videos 214.

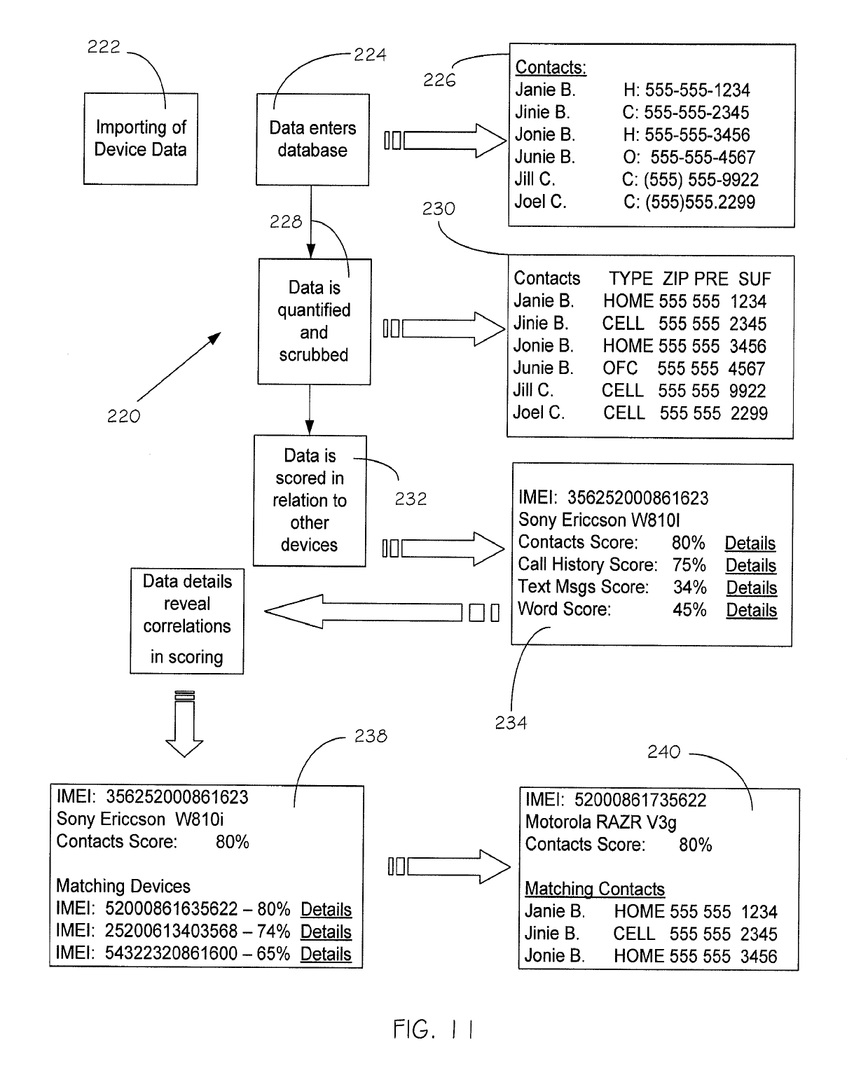

FIG. 11 illustrates a correlation flowchart 220 of the present invention which can be used to correlate data from different databases found within a single digital or electronic device such as a cell phone. At step 222 the forensic system begins importing device data into one of its databases at step 224. As previously described, the particular device being examined can generate a plurality of contacts which is shown in a contact file 226, including a number of names and phone numbers. Once the contact file 226 has been generated, this data is quantified and scrubbed by the software at step 228. As can be seen, the contact information has been organized into an organized format at block 230 where the contact names are listed in a single vertical column and the location of the phone and phone number is illustrated horizontally with the associated name. Once the data has been quantified and scrubbed at step 228, data is stored in relation to other device data at step 232. The contact data, the call history data, and the text message data is compared to data which has been stored with respect to other devices. At block 234 this data is given a correlation score. For instance, the contact score has a rating of 80%, the call history score has a rating of 75%, the text messages score has a rating of 34% and the word score has a rating of 45%. Correlation scores are based on relationships between previously entered data. Scoring can be made with the use of many types of known matching algorithms. For instance matching of data can be made by matching of area codes, matching of prefixes, matching of suffixes, matching of contacts, matching of text, matching of image names, images, and related hash functions, matching of video names, videos, and related hash functions. The correlation score indicates a percentage match between the various data being compared.

By using the data which has been scored at step 232 and displayed in block 234, it is possible to examine the details of the correlation in scoring at step 236. For instance, by clicking on the “Details” of the contact score in block 238, it is possible to determine which matching devices have similar contacts. Consequently, by looking at the generated table of data at step 238 it can be seen that the first noted device having the IMEI number ending in 622 has a contact score of 80% with another device. It can also been seen that the device having the last three digits of 568 has a 74% correlation and the third device having the last three numbers of 600 has a 65% correlation. By clicking on the details of the device having the 622 three digits, it can be seen at block 240 that the matching contacts include three individuals. The three individuals are shown and include their telephone numbers which can either be a home number, a cell phone number, or other.

The data 240 also provides the corresponding information of the matching device having an IMEI number, the type of phone and the contact score.

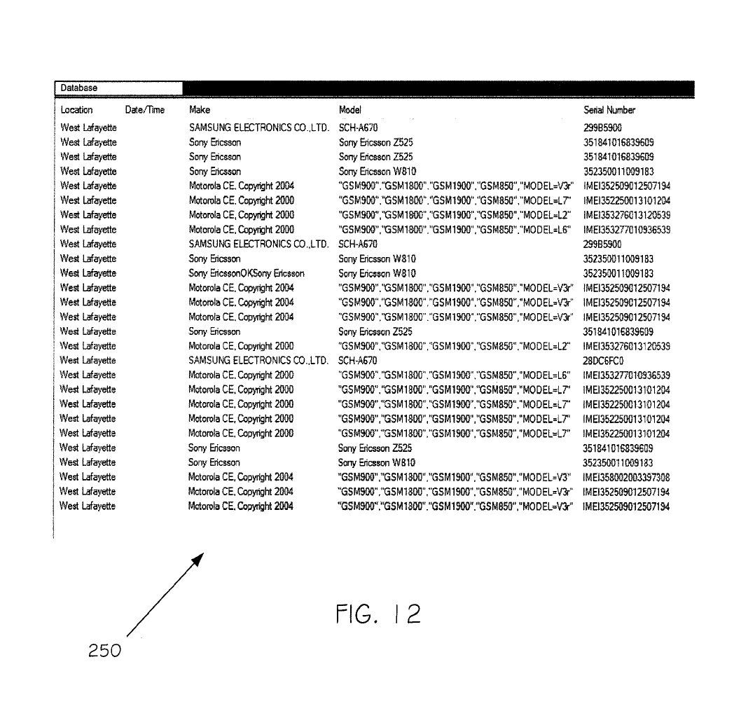

Each of the individual forensic systems 10 include an internal memory which can store a large amount of data acquired from many individual devices. Each of the devices being examined can include the previously described data. The present invention can take the data from all the electronic devices and organize and tabulate this data in a single data base as illustrated in FIG. 12.

The present invention can generate a screen shot 250 of an initial repository state where each of the devices examined by a single unit 10 is listed with a make, a model, and a serial number of the device. In addition, the location of the unit repository can be indicated by the city, state, and/or country. As can be seen in the screen shot 250 of FIG. 12, a single forensic system 10 can have all of its individual databases downloaded into a particular location, which is for instance listed herein as West Lafayette, Ind.

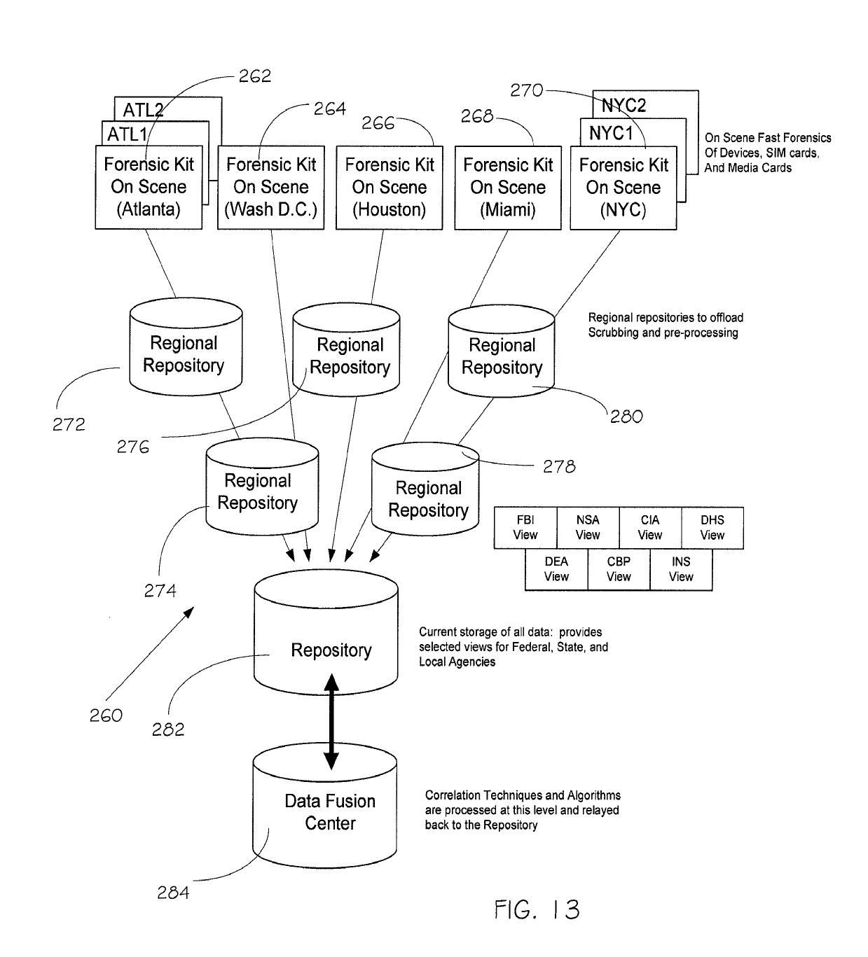

The utility of being able to store all related device information at a single location is further illustrated in FIG. 13 which illustrates a multiple unit access flowchart 260. The multiple unit access flowchart 260 illustrates that a number of individual locations, here indicated as cities, can each have their own forensic system 10 residing at that city. Multiple forensic units can be located at a single city or location. For instance, the locations can include an Atlanta location 262, a Washington, D.C. location 264, a Houston location 266, a Miami location 268 and a New York City location 270. Each individual location can include data from one or more forensic systems 10 as described herein. Once each of the individual forensic systems has been used in the field, the data which has been collected and stored on scene by a forensic system 10 can be downloaded to a respective regional repository 272, 274, 276, 278, and 280.

Each of the regional repositories stores data scrubbed and processed and available from a forensic kit 10. All of the regional repositories are in turn coupled to a central repository 282 which includes a current storage location of all data. The central repository can include preselected views of data which are typically organized with a view towards the type of data an agency typically examines. For instance, different views might exist for the FBI, NSA, CIA, DHS, DEA, CBP, and the INS. A data fusion center 284 is coupled to the repository 282 and can be located at the same geographical location or can be located at another location. The data fusion center can use correlation techniques and various algorithms to process and relay certain information back to the repository which can be useful for each of the prior described federal, state, and local agencies.

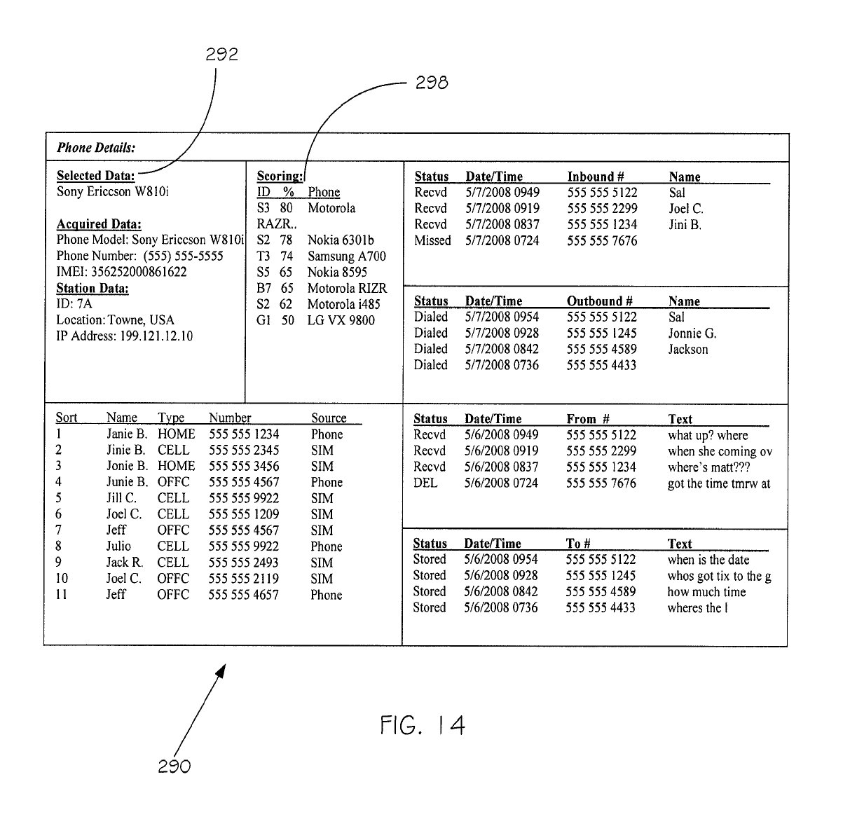

FIG. 14 illustrates an example of a view of one of the individual screens located at and accessible at any one of the evidence repositories. As can be seen in the screen 290, the acquired data of a selected phone 292 can be examined. The acquired data 294 from the phone is listed and the correlation scoring 298 is also provided. The correlation data 298 indicates what percentage of correlation has occurred between the selected data phone 292 and other phones listed here which include a Motorola phone, a Nokia phone, and a Samsung phone as examples. Further information can also be examined in the screen 290 which includes a sort on names based on correlation. The correlation can be a check for matches between the between databases of difference devices. For instance, if a first phone includes a list of 10 contacts and a second different phone includes a list of 10 contacts, the two lists are compared to see if any of the contacts appear on both lists. If the contact list of the first phone includes 6 contacts found in the contact list of the second phone, then the correlation percentage is 60%. In addition, it can also be seen where particular messages have either been received, missed dialed or stored in the Sony Ericcson phone.

The home screen 100 is illustrated in FIG. 15 and includes the read device icon 106, the read SIM icon 108, and the read media icon 110. In addition to those three icons, the user interface 100 includes along the left hand column an access icon 300, an identity icon 302, a status icon 304, and an administration (ADMIN) icon 306. Also included are a database icon 308 and a standby icon 310.

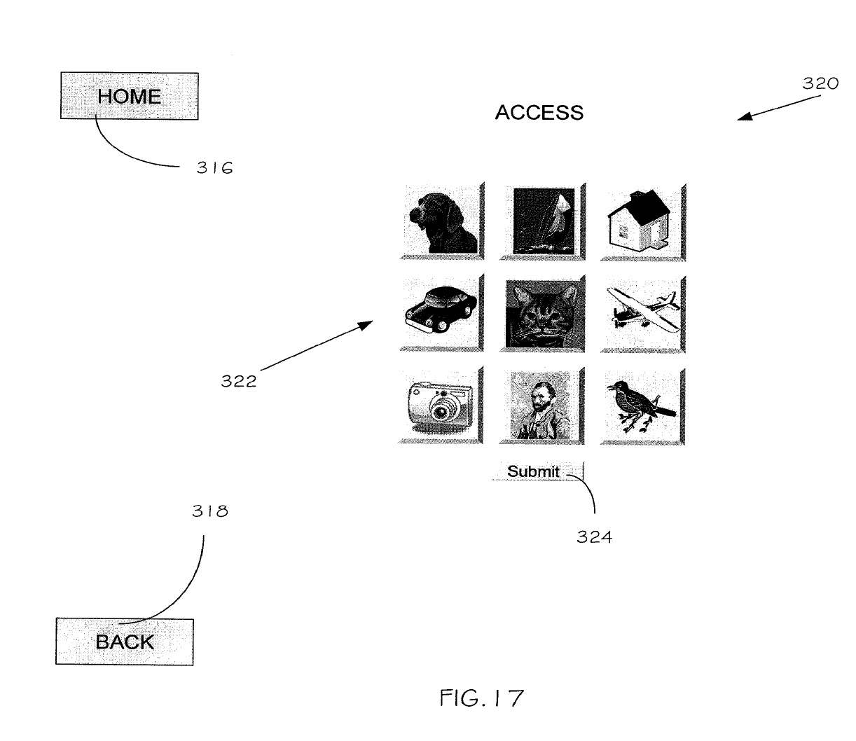

Upon selection of the access icon 300 of the home screen 100, an access screen 312 is selected and appears as illustrated in FIG. 16. As can be seen in this access screen, a user can submit their individual name in the user box 314. Once the user has indicated a proper user name upon selection of the submit button 315, the software program will proceed to the user interface screen of FIG. 17. The user interface screen 312 of FIG. 16 also includes a home icon 316 to return to the home screen 100 and a back icon 318 which returns the user to the previous screen.

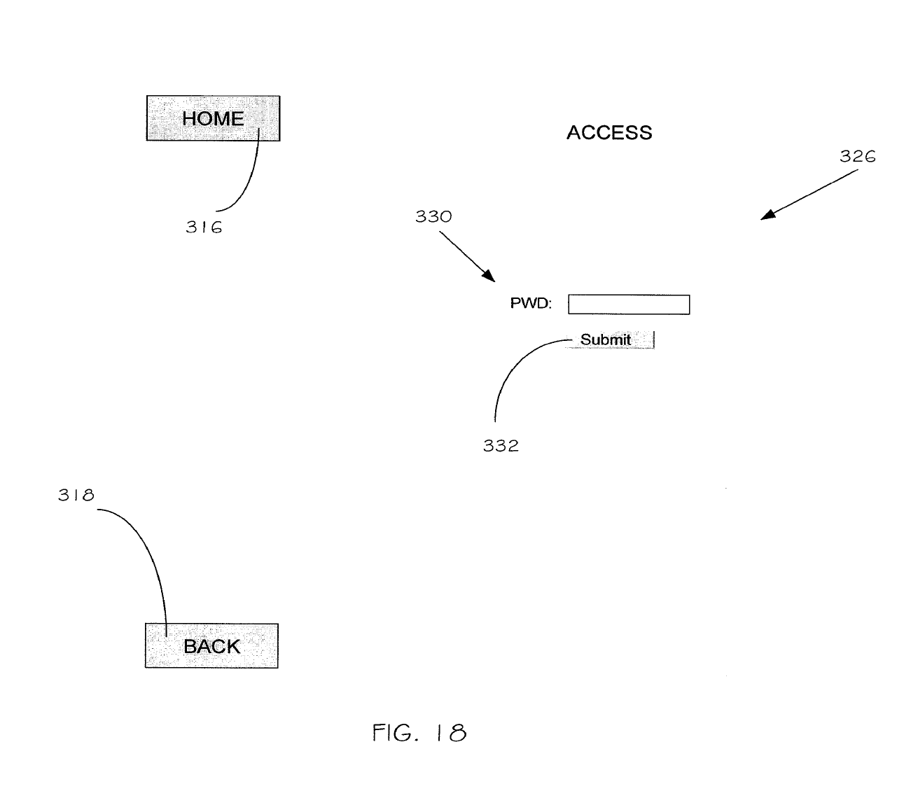

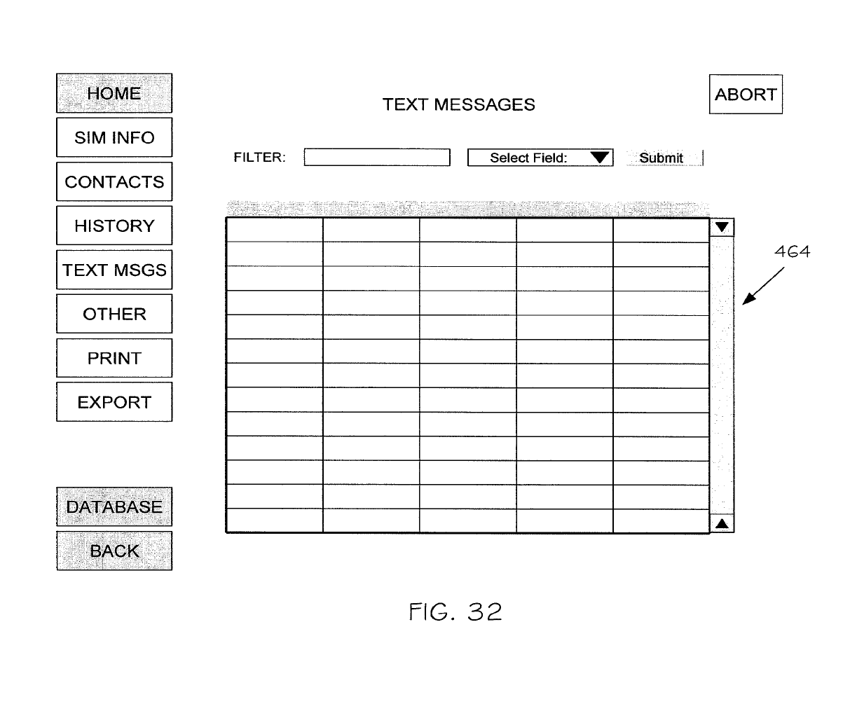

As illustrated in FIG. 17, the access user interface screen 320 includes the previously described home icon 316 and back icon 318 having the same functions. In addition, in the center of the screen a number of icons appear which can be selected by the user. For instance, instead of having an individual user name as an input, the user screen of FIG. 32 can include a number of predetermined icons 322 each one being assigned to an individual who might be using the system. Upon selection of one of the icons 322 and a submit icon 324, the software program proceeds to the user interface screen 326 of FIG. 18. The user interface screen 326 of FIG. 18 includes the previously described home icon 316 and back icon 318. In addition, this particular user interface screen 326 includes a password box 330 which requires that the user submit a correct user password in the box.

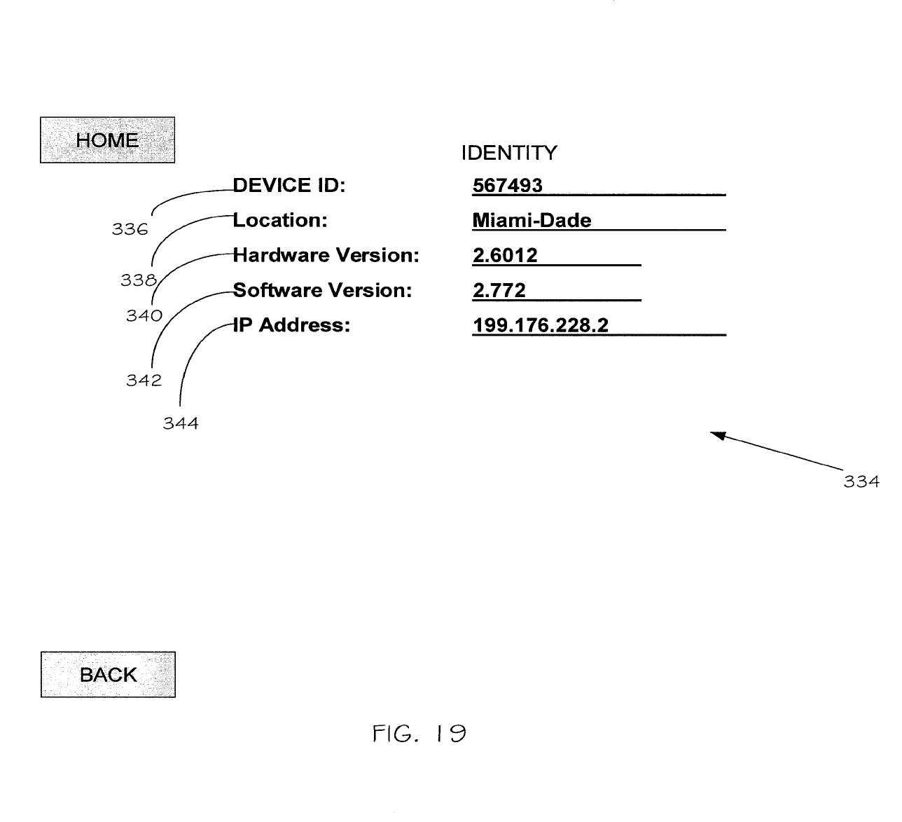

Upon submission of the submit icon 332, the user can return to the home screen of FIG. 15 and access the remaining icons as indicated as follows. If the user should select the identity icon 302, a user interface screen 334 of FIG. 19 is provided by the system for viewing by the user. As can be seen in FIG. 19, the screen provides a device ID 336 which is the identification number of the forensic kit currently being used. The information also includes the assigned location 338 of the device, the hardware version 340, the software version 342, and the IP address 344.

If, however, the user selects the status icon 304 of FIG. 15, a status screen 350 is provided by the system for viewing by the user. The status screen 350 includes a session indicator having in this case a number 157. The session 352 indicates that this is the 157^{th} particular session performed by the forensic system. An online status box 354 also indicates that the device has been in use and online since a date of Nov. 14, 2007. It also indicates a last update 356 indicating a last software update, a device is indication 358 that 15 devices have been examined in the current session, and an Others indication 360 indicating that 354 devices are currently online. In addition, a date indication 362, a time indication 364, and a current user indication 366 can also be included in this screen.

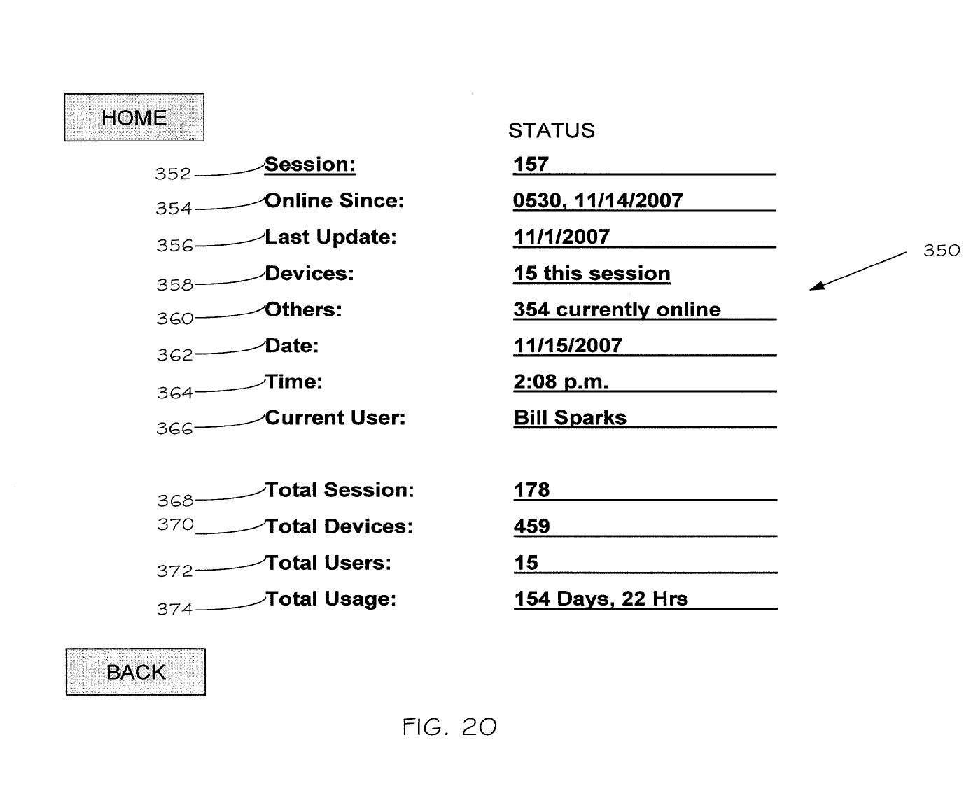

Towards the bottom of the user interface screen of FIG. 20, a total session indicator 368 indicates the total number of sessions experienced by the present system 10, a total devices indicator 370 indicates the number of total devices read by the current system 10 in use, a total users indication 372 indicates the number of users which have used the device since it came online and a total usage indicator 374 indicates how many days and hours the current system has actually been in use.

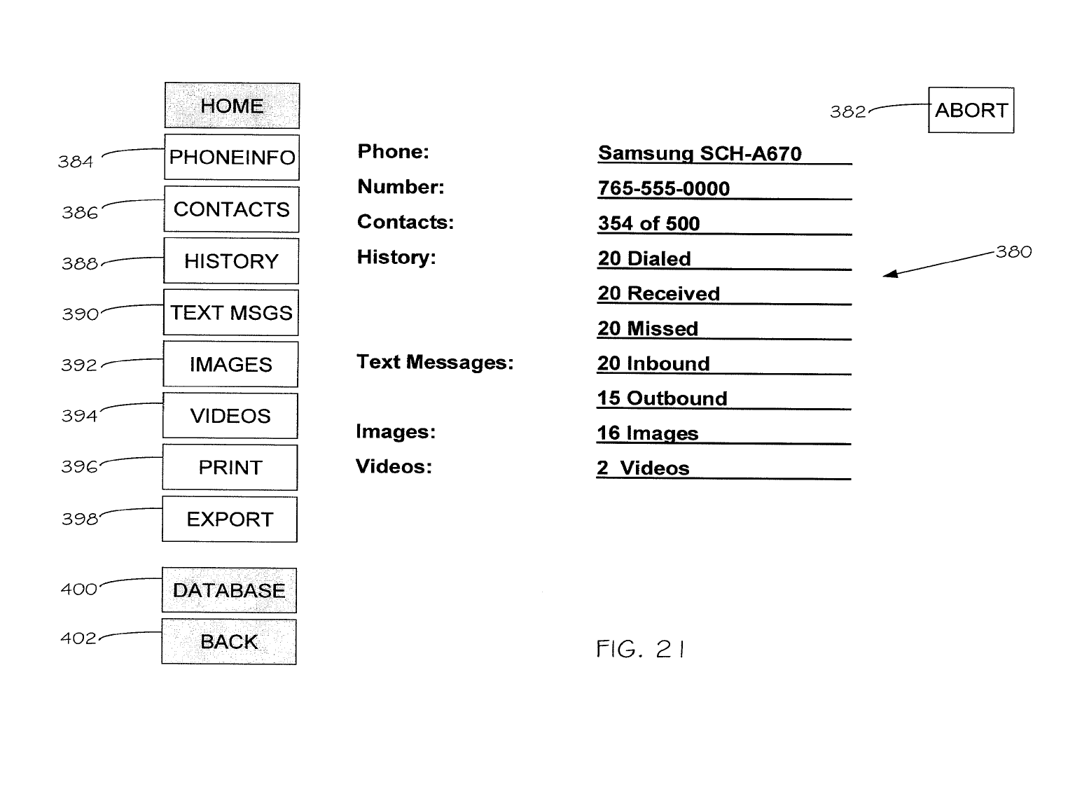

If the user selects the read device icon 106 of FIG. 15, the user interface screen 380 of FIG. 21 appears. As can be seen, this particular user interface includes an abort icon 382 which can be used to quickly abort a session to prevent the information in the system from being accessible to any one who does not have the necessary user name and password. As previously described upon connection of a particular device, the read device flowchart indicates that a device can be read and provide a variety of information. As illustrated in FIG. 21, a variety of information can be selected through a number of user interface icons located along the left hand side of the screen 380. For instance, the phone information indicator 384 can be selected to provide the phone information to be described later. In addition, additional icons include a contacts icon 386, a history icon 388, a text messages icon 390, an images icon 392, a video icon 394, a print icon 396, and an export icon 398. A database icon 400 is included as well as a back icon 402 which is as previously described. Once the screen of FIG. 21 appears, the central portion of the user interface screen includes a summary of data or other information retrieved from the device such as the summaries illustrated. For instance, the type of phone, the phone number, the number of contacts, a history of those contacts, the number of text messages, the number of images, and the number of videos.

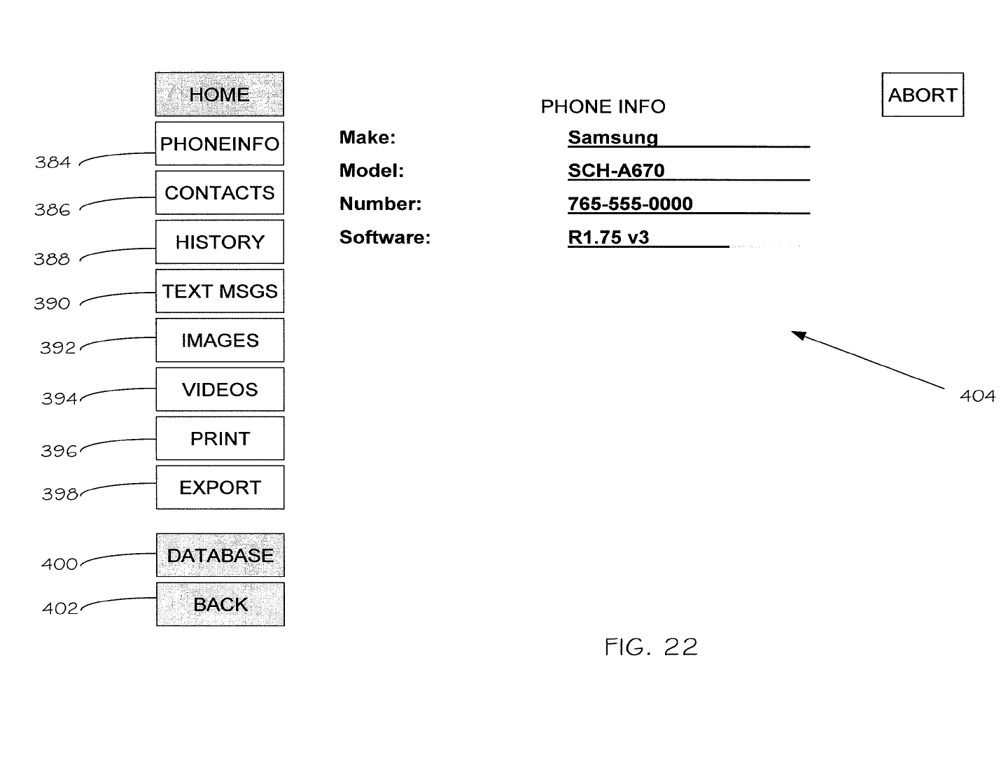

If for instance the phone info icon of FIG. 21 has been selected, the user interface screen 404 of FIG. 22 presents the phone information typically in the central portion of the screen. Each of the left hand icons remain for selection of additional information. As can be seen, the phone information can include the make, the model, the telephone number as well as the type of software being used.

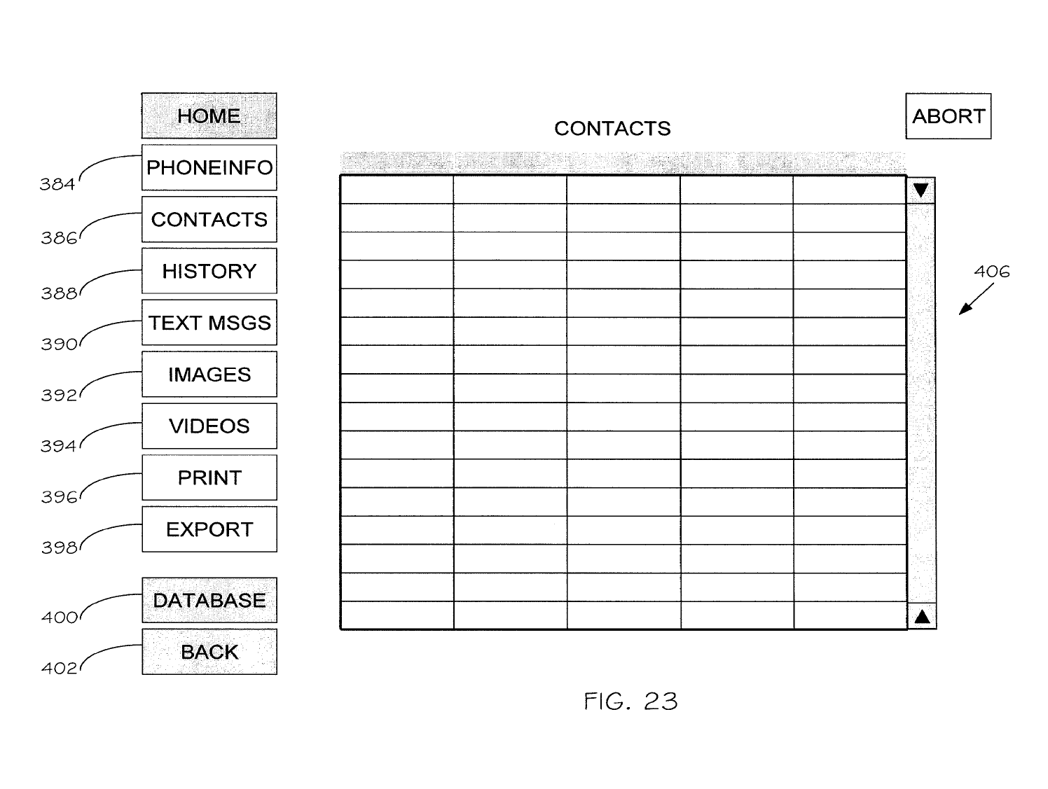

If the contacts icon 386 has been selected, the user interface screen 406 of FIG. 23 is displayed. The contacts can be organized alphabetically and can include names, phone numbers, and other available information.

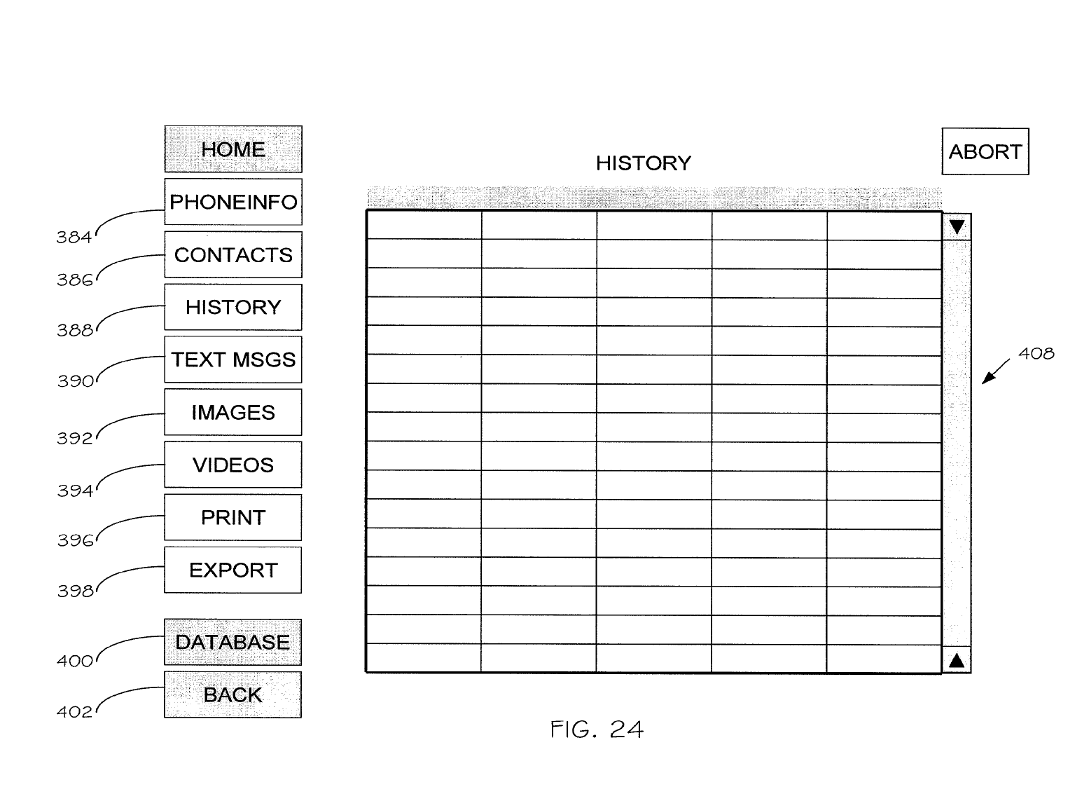

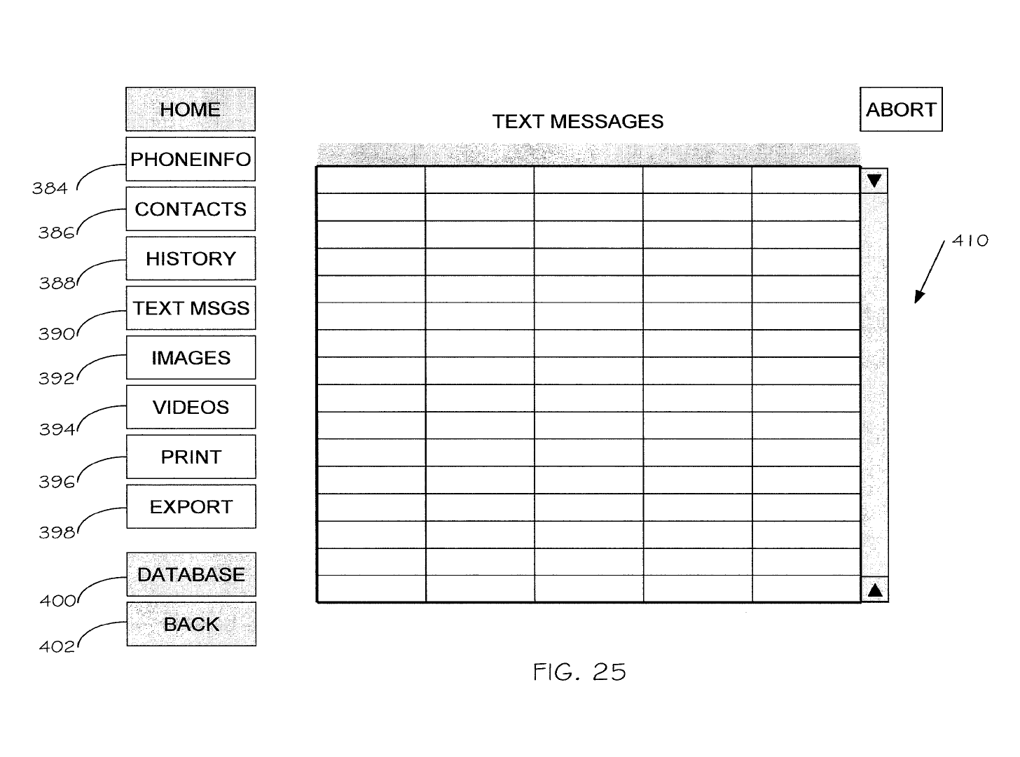

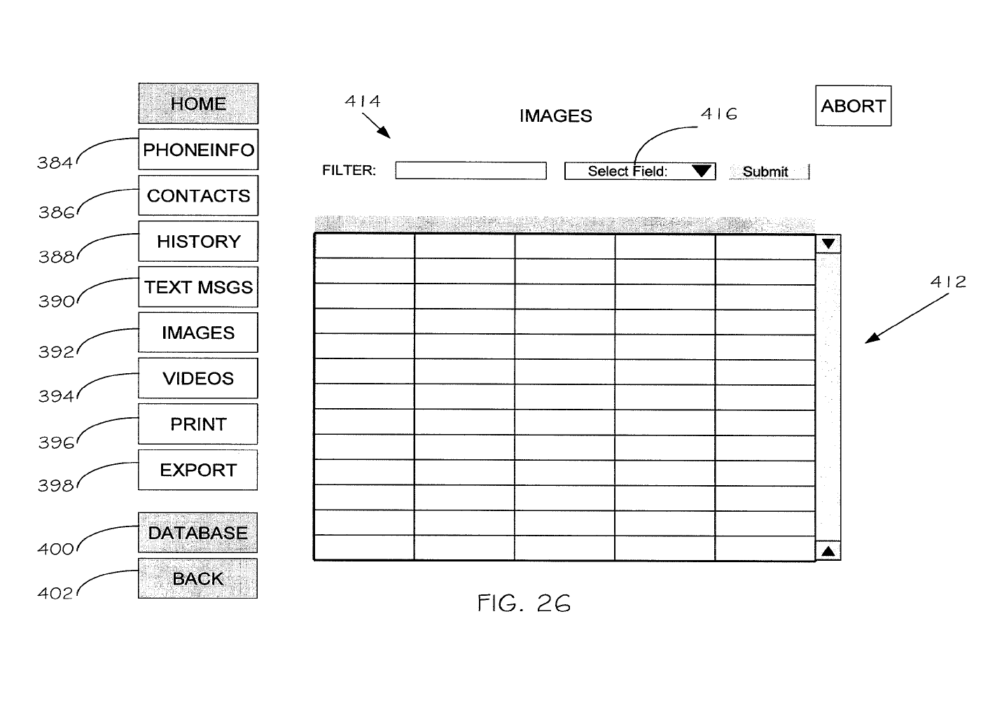

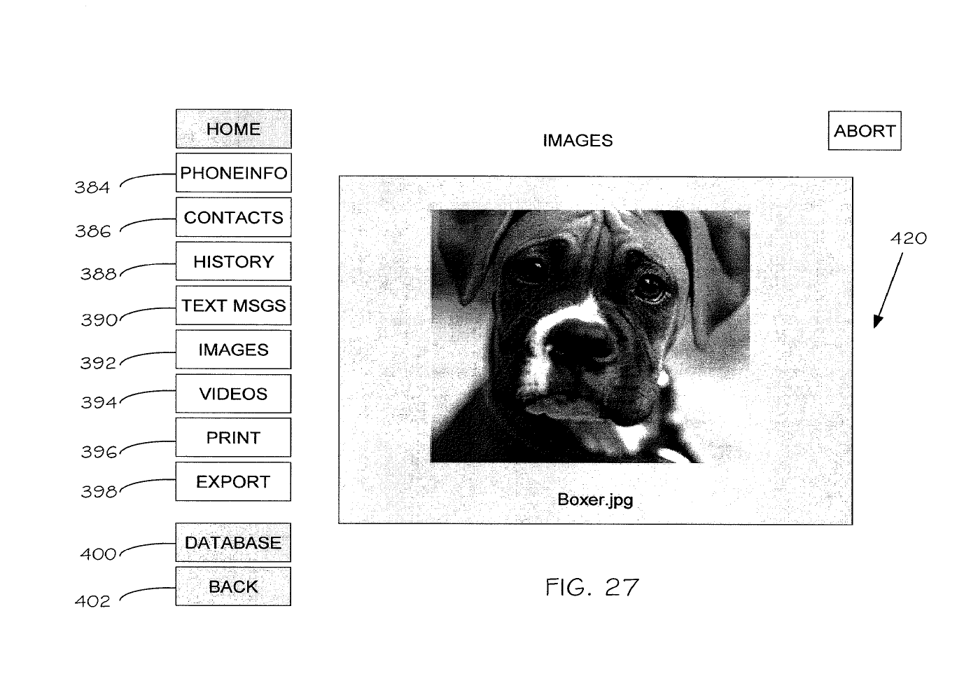

If the history icon 388 is selected, then the user interface screen 408 of FIG. 24 is displayed. If the user icon text messages 390 is displayed then the user interface screen 410 of FIG. 25 is selected. If the user interface icon images 392 is selected, then the user interface screen 412 of FIG. 26 is provided. As can be seen in user interface screen 412, a filter box 414 includes a section for the input of data to provide for searching according to data in the box 414 based on the selected item in a pull down menu 416. By selecting a search field 416 and inputting data into the filter box 414, a particular image can be accessed. The image itself can be displayed to the user in a user interface screen 420 of FIG. 27 as illustrated.

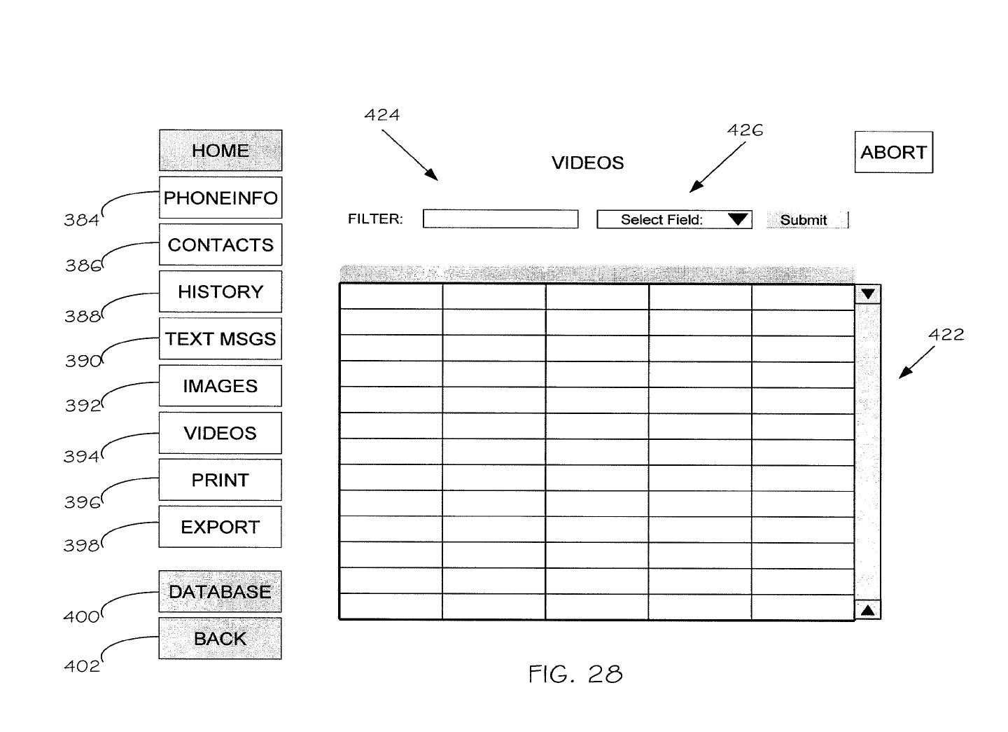

If the videos icon 394 has been selected, the system displays a user interface screen 422 of FIG. 28. The central portion of the user interface screen for the videos is similar to the previously described screen for the images in that multiple rows appear which would be populated by the names of videos. In addition, the user interface screen 422 includes a filter box 424 and a pull down menu for selecting a field 426 as previously described. A video of interest can be selected from the list and can be displayed in a fashion similar to the display of images of FIG. 27.

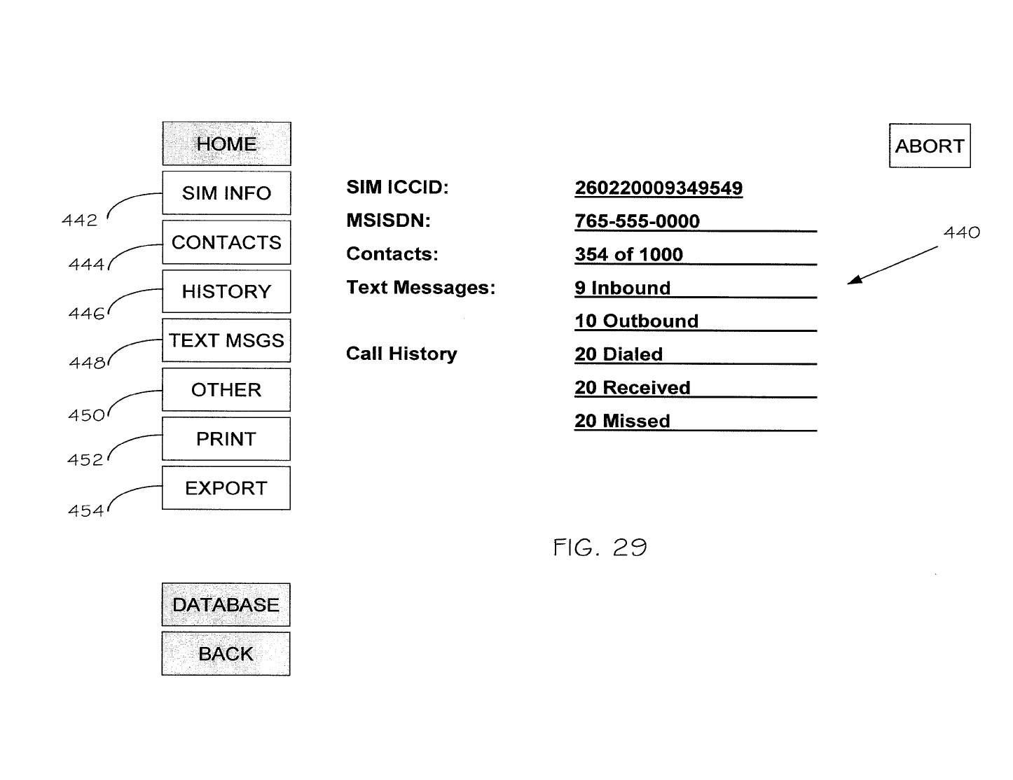

Returning to FIG. 15, should the user wish to read the SIM card, the user selects the read SIM icon 108. Once the read SIM icon has been selected, the user interface screen 440 of FIG. 29 is displayed. As illustrated, the user interface 440 includes a SIM ID an MSISNN number, a contacts section, the number of text messages either inbound or outbound and a call history. In addition, the user interface 440 includes a SIM info icon 442, a contacts icon 444, a history icon 446, a text messages icon 448, an other icon 450, a print icon 452, and an export icon 454. In addition, a home icon, a database icon, and a back icon are included as previously described as well as an abort icon.

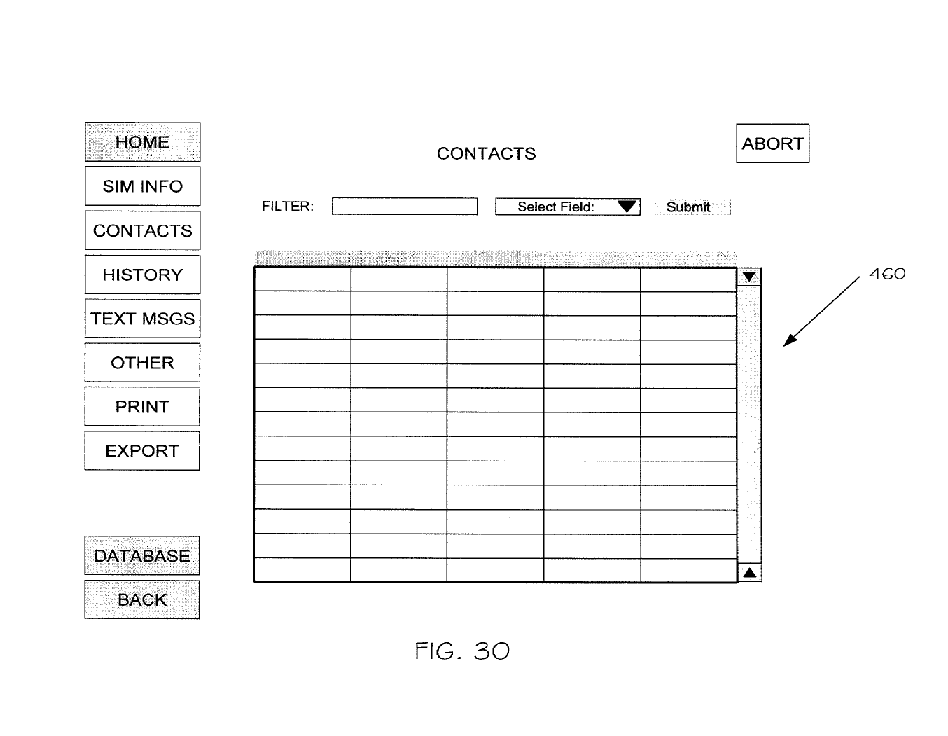

Each of the icons along the left hand side when selected can cause the system to display additional user interface screens corresponding to the selected icon. For instance, a SIM info icon can cause the user interface screen 460 of FIG. 30 to appear. This screen as well as the other screens related to the icons just described for FIG. 29 all include similar features including a filter box and a pull down menu box for searching the particular information.

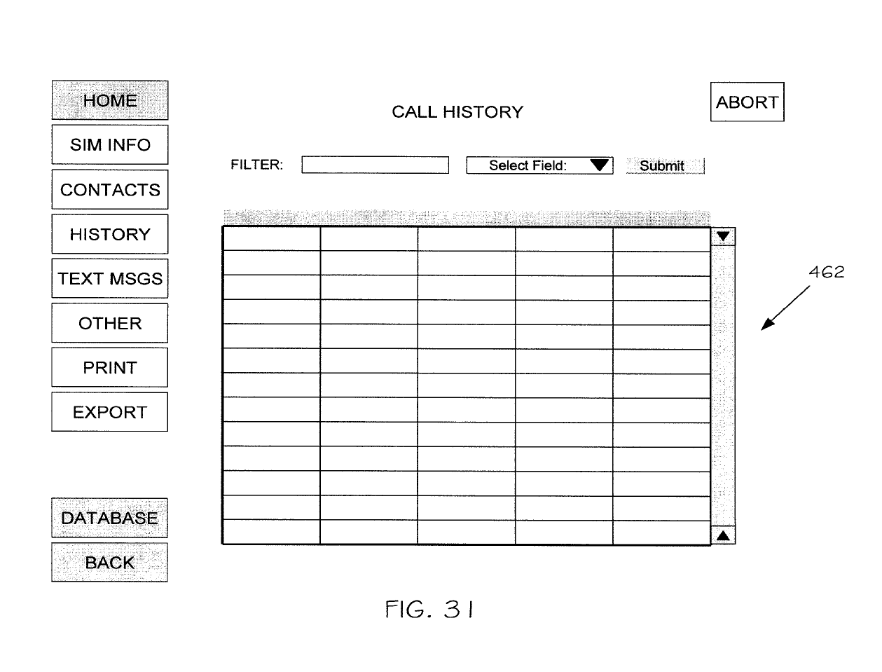

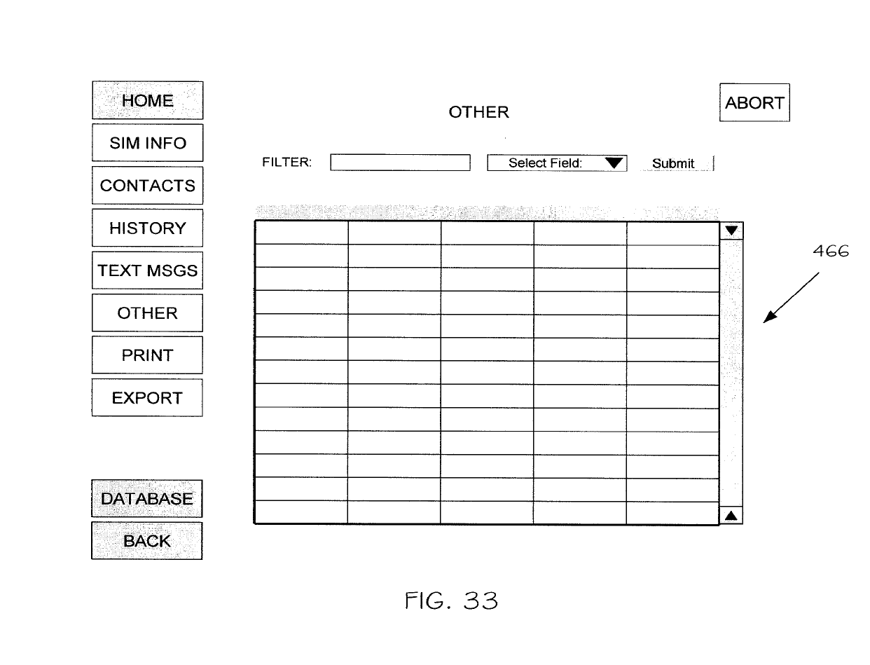

As further illustrated in a user interface screen 462 of FIG. 31, a call history screen is displayed. FIG. 32 illustrates a user interface screen 464 providing a list of illustrating text messages. FIG. 33 illustrates a user interface screen 466 providing other information.

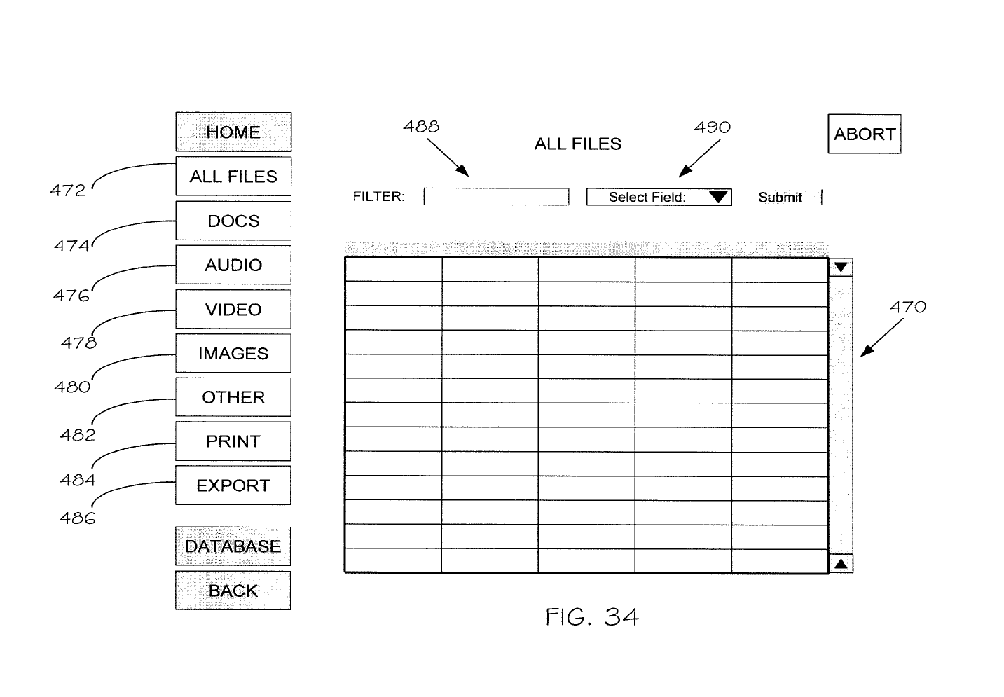

Upon selection of the read media icon 110 of FIG. 15, a user interface screen 470 of FIG. 34 is displayed. In this particular user interface screen, it can be seen that an all files icon 472, a docs icon 474, an audio icon 476, a video icon 478, an images icon 480, and other icon 482, a print icon 484, and an export icon 486 are included. Selection of each of these icons can cause the system to display a related user interface screen related to the icons located on the left. Each of the displayed user interface screens can include a filter box 488 and a pull down menu 490. The other user interface screens are not illustrated since they follow a format similar to those previously described.

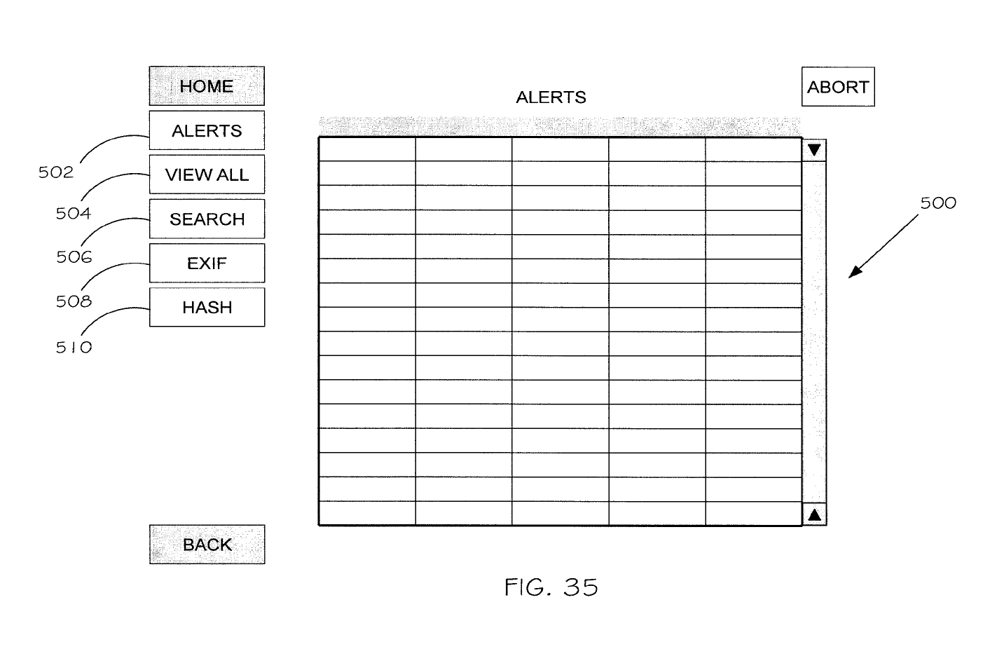

Once the user has completed the read media portion of the device, the user can also select for viewing the database 308 contained within the system 10 in user. By selection of the database icon 308 of FIG. 15, a database user interface screen 500 of FIG. 35 can be displayed. Upon selection of the data user interface screen, the screen 500 is displayed and includes an alerts icon 502, a view all icon 504, a search icon 506, an EXIF (exchangeable image file format) icon 508 and a HASH icon 510. The search icon 506 lists files having an EXIF function while the HASH icon lists files having a HASH function. The alert user interface screen 500 can list a number of alerts in rows and columns which can provide an alerting function to the user where there are files which may be related to other files and which may be of interest. Upon selection of the view all, search, EXIF, and HASH icons, additional user interface screens will be displayed as previously described each of which can include a search field document data as well as a pull down menu for a select field.

While exemplary embodiments incorporating the principles of the present teachings have been disclosed hereinabove, the present teachings are not limited to the disclosed embodiments. Instead, this application is intended to cover any variations, uses, or adaptations of the invention using its general principles. Further, this application is intended to cover such departures from the present disclosure as come within known or customary practice in the art to which this invention pertains.

1-28. (canceled)

29. A system for extracting information from a personal digital device, comprising:
a connection hub;
a plurality of cables coupled to the connection hub, each cable including a connector configured to connect to at least one type of personal digital device; and
a computing device configured to receive data from a personal digital device connected to at least one of the plurality of cables and to display data received from the personal digital device to a user.

30. The system of claim 29, further comprising:
a plurality of illumination devices, each illumination device corresponding to a cable in the plurality of cables,
wherein the computing device is configured to send a signal to illuminate at least one of the plurality of illumination devices to indicate to a user to connect a personal digital device to the cable corresponding to the illuminated illumination device.

31. The system of claim 30, wherein the computing device is configured to:
(a) present a plurality of types of personal digital devices to a user;
(b) receive selection from the user of a type of personal digital device from the plurality of personal digital devices;
(c) determine which connector is configured to connect to the selected type of personal digital device, and
(d) send the signal to illuminate an illumination device from the plurality of illumination devices corresponding to the connector configured to connect to the selected type of personal digital device.

32. The system of claim 30, wherein the computing device is configured to:
(a) receive a first selection from the user indicating a region of the personal digital device;
(b) receive a second selection from the user indicating a carrier of the personal digital device;
(c) receive a third selection from the user indicating a type of antenna of the personal digital device;
(d) receive a fourth selection from the user indicating an style of the personal digital device,
(e) receive a fifth selection from the user indicating a manufacturer of the personal digital device,
(f) receive a sixth selection from the user indicating whether the personal digital device has a camera,
(g) determine a type of personal digital device according to the region, carrier, type of antenna, style, manufacturer and whether the device has a camera, and
(h) send the signal to illuminate an illumination device from the plurality of illumination devices corresponding to the connector configured to connect to the determined type of personal digital device.

33. The system of claim 29, wherein each of the cables is fixed to the connection hub so as to prevent loss of the cables.

34. The system of claim 29, further comprising:
a plurality of locks, each lock attaching a cable from the plurality of cables to the connection hub so as to prevent loss of the cables.

35. The system of claim 29, wherein the connected personal digital device is a mobile phone, SIM card, multimedia card, personal digital assistant, smart phone, or USB device.

36. The system of claim 29, wherein the computing device is configured to stream in data from the personal digital device.

37. The system of claim 29, wherein the computing device is configured to export data to a remote repository.

38. The system of claim 37, wherein the computing device is configured to receive a score indicating a degree of correlation between at least a portion of the data exported to the remote repository and at least a portion of the data residing in the remote repository.

39. A method for extracting information from a personal digital device, comprising:
(a) sending a signal to illuminate at least one of a plurality of illumination devices to indicate to a user to connect a personal digital device to a cable from a plurality of cables coupled to a connection hub, the cable corresponding to the illuminated illumination device;
(b) receiving data from the connected personal digital device; and
(c) displaying data received from the connected personal device to a user.

40. The method of claim 39, further comprising:
(d) presenting a plurality of types of personal digital devices to a user;
(e) receiving a selection from the user of a type of personal digital device from the plurality of personal digital devices; and
(f) determining which connector is configured to connect to the selected type of personal digital device,
wherein the sending (a) comprises sending the signal to illuminate an illumination device from the plurality of illumination devices corresponding to the connector configured to connect to the selected type of personal digital device.

41. The system of claim 39, further comprising:
(d) receiving a first selection from the user indicating a region of the personal digital device;
(e) receiving a second selection from the user indicating a carrier of the personal digital device;
(f) receiving a third selection from the user indicating a type of antenna of the personal digital device;
(g) receiving a fourth selection from the user indicating an style of the personal digital device,
(h) receiving a fifth selection from the user indicating a manufacturer of the personal digital device,
(i) receiving a sixth selection from the user indicating whether the personal digital device has a camera,
(j) determining a type of personal digital device according to the region, carrier, type of antenna, style, manufacturer and whether the device has a camera, and
(k) sending the signal to illuminate an illumination device from the plurality of illumination devices corresponding to the connector configured to connect to the determined type of personal digital device.

42. The method of claim 37, wherein each of the cables is locked to the connection hub so as to prevent loss of the cables.

43. The method of claim 37, wherein the connected personal digital device is a mobile phone, SIM card, multimedia card, personal digital assistant, smart phone, or USB device.

44. The method of claim 37, wherein the receiving (c) comprises streaming data from the personal digital device.

45. The method of claim 37, further comprising:
(d) exporting data to a remote repository.

46. The method of claim 45, further comprising:
(e) receiving a score indicating a degree of correlation between at least a portion of the data exported to the remote repository and at least a portion of the data residing in the remote repository.

47. A system for collecting and analyzing data from personal digital devices, comprising:
a repository that receives and stores data extracted from personal digital devices by a plurality of forensic kits, each forensic kit configured to extract device from a plurality of different types of personal digital devices; and
a data fusion center, coupled to the repository, that correlates data extracted from a plurality of the personal digital devices.

48. The system of claim 47, wherein the repository provides a plurality of views for the data extracted from personal digital devices, each view customized for a particular government agency.

49. The system of claim 47, further comprising:
a plurality of regional repositories coupled to the repository, each regional repository storing data extracted from personal digital devices from forensic kits in a particular geographic region.

50. The system of claim 47, wherein the data fusion center determines a percentage of contacts extracted from a first personal device that match contacts extracted from a second personal digital device,
wherein different forensic kits extracted data from the first personal device and the second personal digital device.

51. A portable forensic kit for extracting information from a personal digital device, comprising:
a connection hub;
a plurality of cables coupled to the connection hub, each cable including a connector configured to connect to at least one type of personal digital device, wherein each cable is fixed to the connection hub so as to prevent loss of cables;
a plurality of illumination devices, each illumination device corresponding to a cable in the plurality of cables; and
a computing device configured to:
send a signal to illuminate at least one of the plurality of illumination devices to indicate to a user to connect a personal digital device to the cable corresponding to the illuminated illumination device, and
receive data from a personal digital device connected to at least one of the plurality of cables and to display data received from the personal digital device to a user.
